(19) United States
(12) Patent Application Publication
(10) Pub. No.: US 2019/0296844 A1
(43) Pub. Date: Sep. 26, 2019

(54) AUGMENTED INTERACTIVITY FOR BROADCAST PROGRAMS

(71) Applicant: Social Media Labs, Inc., Nashville, TN (US)

(72) Inventors: Byron Trent CORDER, Nashville, TN (US); Renato Christopher MARINO, Lebanon, TN (US); Wilbur Leslie DUBLIN, Austin, TX (US)

(73) Assignee: Social Media Labs, Inc., Nashville, TN (US)

(21) Appl. No.: 16/362,442

(22) Filed: Mar. 22, 2019

Related U.S. Application Data
(60) Provisional application No. 62/647,257, filed on Mar. 23, 2018.

(51) Int. Cl. H04H 60/19; H04N 21/2187; H04N 21/242; H04H 60/29

(52) U.S. Cl. CPC H04H 60/19; H04H 60/29; H04N 21/242; H04N 21/2187

(57) ABSTRACT

Disclosed is an audience app, a computing device that allows the user to select a broadcast program, establish a wireless communication channel with a remote server, transmit program selection data identifying the selected broadcast program to the remote server, receive auxiliary program information content, data and/or instructions correlated to the selected broadcast program, and using the auxiliary program information, generate and display local content correlated to and in temporal coordination with the selected broadcast program. Also disclosed are a server that serves the audience app, a broadcast interactivity system comprising the server, a show management server, a show preparation computing device, and a social history server, and a broadcast interactivity system with at least one audio fingerprint server.

This Application claims priority to and incorporates by reference in its entirety U.S. Provisional Patent Application No. 62/647,257, filed Mar. 23, 2018.

### FIELD OF THE INVENTION

The present invention relates generally to the field of broadcast communication.

### BACKGROUND

For nearly a century, large audiences have been served by the broadcasting of Radio and Television programs, and more recently, even by other electronic publishing media that may not be strictly real-time broadcasts (such as podcasts, audio and video streaming (either live or on demand), and blogs and websites). In each of these scenarios, though, there is a missing, critical factor: Because of the inherently unidirectional nature of broadcast and similar media, it is awkward at best to engage audience members in any kind of meaningful, useful, and valuable interactivity. Over the years, various methods have been tried to loosely connect content programmers and audiences in interactivity loops, but most of these, including the most popular and successful, telephone call-ins, are very awkward and limited. Others, such as urging audience members to remember telephone numbers, URLs, or appeals to connect via third-party social media are either of limited usefulness within the timeframe of the broadcast or may even involve sending the valuable audience to potential competitors, such as large social media sites.

The past few years have seen the rapid rise of wirelessly connected mobile devices to the point of ubiquity—virtually every person living in developed (and even many relatively undeveloped) areas of the world now has access to such hardware devices and networks. These devices, variously known as smartphones, tablets, laptops, and two-in-ones merge the functions of powerful local computing with high-performance visual displays (recently, often superior to desktop computers), touch and other interfaces (accelerometers, GPS and compass, etc.), and high-performance wireless networks (from short range networks such as Bluetooth and Wi-Fi to long range “carrier” networks, such as LTE, GSM, and CDMA).

There is currently a need for a technological integration of mobile devices and networked servers to provide interactivity between program providers (via broadcast, streaming, or via the Internet, the World Wide Web, or other similar data networks) and individual audience members.

### SUMMARY

Embodiments of the present invention integrate social networks and mobile “apps” with broadcast or on demand streaming content networks to provide closed loop interaction. Such integration provides benefits to the broadcasters and/or content producers, the individual members of the audience for the content, and a diverse set of communities such as advertisers, business owners, fans, and other community groups and constituencies, over the lifespan of the audience relationship.

Disclosed is an embodiment of an audience computing device for interacting with a broadcast program, comprising computer instructions stored in memory which when executed by a processor enable the audience computing device to: select a broadcast program; establish a communication channel between the audience computing device and a remote server, the communication channel comprising a connection established by the wireless communication system; transmit program selection data identifying the selected broadcast program to the remote server, receive from the remote server, via the communication channel, auxiliary program information content, data and/or instructions correlated to the selected broadcast program, and store said auxiliary program information in the memory; using the auxiliary program information, generate local content correlated to the selected broadcast program; and display the local content in temporal coordination with the selected broadcast program.

Also disclosed is an embodiment of a server component of a broadcasting interactivity system, comprising a server computer adapted and configured to communicate with at least one audience computing device and further comprising computer instructions stored in memory which when executed by a processor enable the server to: receive broadcast content correlated with a first broadcast program from a show management server; receive program selection data identifying the first broadcast program from said audience computing device via the communications channel; and transmit to the audience computing device via the communications channel auxiliary program information correlated to the first broadcast program.

Also disclosed are embodiments of a broadcasting interactivity system, comprising a network hub server comprising the server functionality described above, a show management server, a show prep computing device, and a social history server. Other embodiments of the broadcasting interactivity system further comprise an audio fingerprint server and at least two audio fingerprint servers serving different metropolitan areas.

### BRIEF DESCRIPTION OF THE DRAWINGS

FIG. 1 shows a schematic diagram of system components of an embodiment.

FIG. 2 illustrates an embodiment of the logical structure of a Content Group.

FIG. 3 illustrates an embodiment of an exemplary mapping of Content Assets, Asset Manifests, and Content Groups.

FIG. 4 shows an embodiment of an exemplary process for processing show content.

FIG. 5 shows a possible embodiment of an exemplary process for loading show content assets into an Audience App.

FIG. 6 shows possible embodiments of exemplary processes for identifying broadcast content.

FIG. 7 illustrates a possible embodiment of a Graphic User Interface screen for with embodiments of the invention

FIG. 8 is a schematic illustration of an embodiment of an exemplary audio fingerprint server for capturing audio “fingerprints” to identify broadcast sources or content.

FIG. 9 is a schematic illustration of an embodiment of an exemplary process for processing speech clips.

FIG. 10 is an illustration of one-touch response for contests and promotions on an exemplary touchscreen interactive device.

FIG. 11 is a schematic representation of internal components of an exemplary embodiment of a Network Hub Server.

FIG. 12 is a block diagram of exemplary components of a mobile wireless communication device.

FIG. 13 is a block diagram of an exemplary communication subsystem

FIG. 14 is a block diagram of exemplary components of a computer or computing device.

FIG. 15 is a timeline diagram illustrating exemplary high-level interactions between broadcast sources and an audience member.

FIG. 16 is a schematic representation of an embodiment of a system to support audience interactivity across multiple geographic regions.

FIG. 17 illustrates the components of an exemplary embodiment of an audience application.

### DETAILED DESCRIPTION

As outlined herein, embodiments of the invention include a number of interconnected systems servers, apps, programs, and devices which may be connected in a variety of ways, including real or virtual wired or wireless networks, via a distributed computing “cloud”, or via colocation on the same physical or virtual server hardware. The function of these systems, and especially their interaction to produce a complete end-to-end system as described herein, provide a number of unique and heretofore impossible or impractical capabilities that can provide strong value to all major actors in a show's ecosystem including those associated with creation, production, and publishing or broadcasting of show content, those seeking to engage in advertising and/or promotions, audience members, and other members of communities that can benefit from the use of such a system. The following paragraphs describe embodiments of the invention and its potential uses in a variety of scenarios to produce a variety of new and valuable capabilities.

Embodiments of the present invention comprise a combination of system components that together form a new kind of social network to allow and facilitate various kinds of live (real time or near real time) interaction between the various participants in the production, distribution, and consumption of an event or “show” (which can be a radio or television broadcast, or a live or on-demand video or audio stream, podcast, blog, etc.)

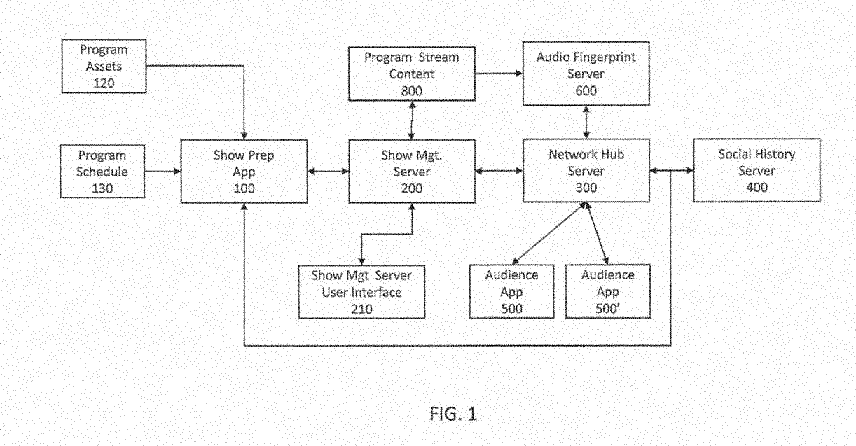

For the sake of presentation here, the major blocks of systems that comprise embodiments of the present invention may, in one preferred embodiment, be grouped into five major categories, as illustrated in FIG. 1.

Show Preparation App (or “Show Prep App”) 100 is an application (or “app”) or device-native or web application designed to run on a mobile or stationary computing device that can be used to setup, plan, control, schedule and manage the production of, and interact with the audience of, a broadcast or other program. The Show Preparation App interfaces directly with the Show Management Server 200 and directly or indirectly with the Network Flub Server 300. Those of ordinary skill in the art will appreciate that a broadcast program includes program assets (120) and a program schedule (130).

In an embodiment, the Show Prep App can interface with either the Show Management Server or the Network Hub Server. In ordinary studio use, the former would be the case, as the direct connection is more reliable and eliminates many potential points of failure and latency, however, for events such as field-sited “remote” show production, the functions of the Show Management App still need to be available, and this is most easily provided and supported by allowing it to communicate via the Network Hub Server. In an embodiment, Show Management Apps running remotely would be given a higher priority by the Network Hub Server, to facilitate keeping them as fully up-to-date as possible.

Show Management Server (or “Show Mgt Server”) 200 optionally provides a Show Management Server User Interface 210 (such as a web application) similar to that of the Show Preparation App 100 (for local use on a desktop, laptop, tablet, or web computer that may not run “Apps” for mobile devices). In addition, the Show Management Server provides storage, processing, and communications and coordination resources required to support the show creation and distribution environment (broadcaster studio, business office, etc.).

Network Hub Server 300 provides for distribution of content to audience members' Audience App 500 devices, and also operates as a communications hub to facilitate communications and synchronization in both directions between the Show Management Server 200 and the Audience App 100.

Social History Server 400 retains historical timeline, social community, and other interactivity data for Shows, Audience Members, and third parties such as advertisers or other entities.

One or more Audience Apps (500, 500′) provide a local user interface (which may be native to the device, web-based, etc.) for interaction by audience members, partially controlled by the show content communicated by the system to the Audience App. The Audience App allows integration of audio/voice, video/camera, GPS/location, other sensors, and touch and user interface functions as appropriate. The user interface of the Audience App in most modes, will preferably be designed to minimize the need for typing or other manual interaction (frequently allowing voice instead), so that it can be more easily and safely used in environments such as moving vehicles.

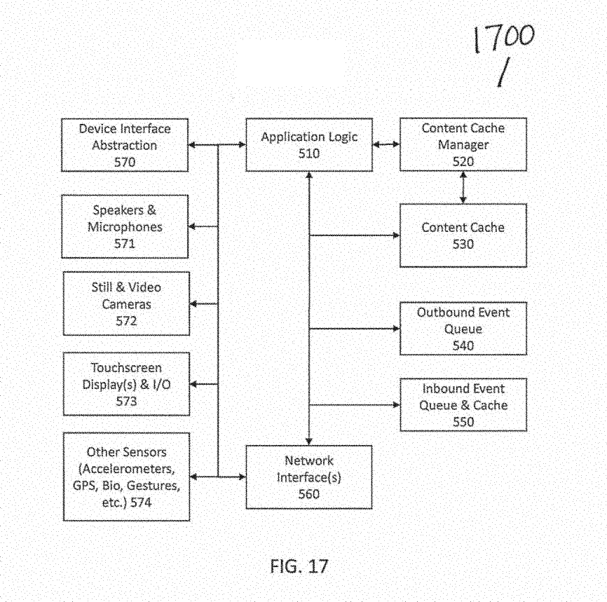

FIG. 17 illustrates components and subsystems of an exemplary embodiment 1700 of an Audience App 500. Some of the components and/or subsystems illustrated in FIG. 17 may be integrated into the physical device the Audience App 500 runs on, such as a smartphone, smart car or home entertainment system, a set-top box, a personal computer or tablet, or other mobile device. In the case of a smartphone, the local device hardware may include real-world sensors, I/O and interface hardware such as Speakers and Microphones 571, front and/or rear-facing still and video cameras 572, other sensors 574, such as accelerometers, GPS or other positioning or navigation sensors (which in an embodiment provide location data consumed by the Audience App), biological sensors (more typically found in “smart watches” which can run applications on a local copy of a smartphone operating system), and gesture sensors, and display(s) and other I/O 573, which in an embodiment include touchscreen display screens and GUI touchscreen input interfaces. Such local device hardware may provide operating system services such as the Device Interface Abstraction 570 or Network Interface(s) 560 (sometimes called a HAL, or Hardware Abstraction Layer) to provide a standard higher-level interface that can hide the variations and complexity inherent in the actual low-level details of the hardware.

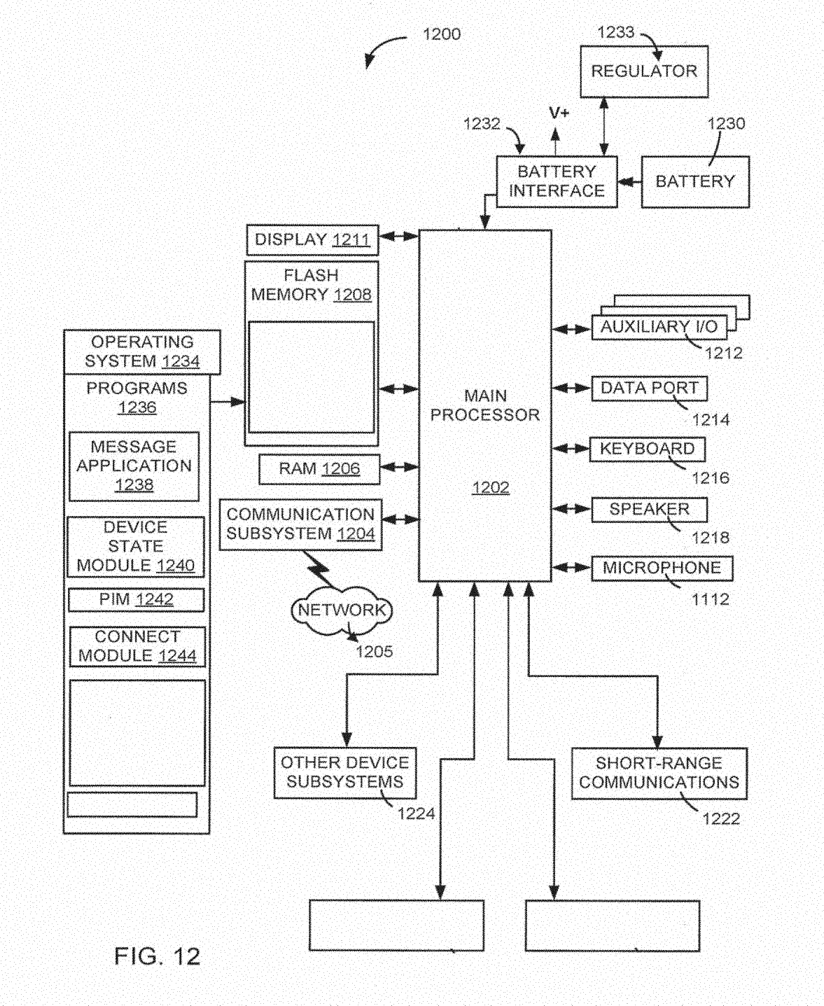

Audience App 1700 includes “mobile app” or application software (or similar software for a PC, web browser, etc.) to enable audience interaction with a broadcast program. Application Logic 510 includes the logic and instructions responsible for managing the different components of the App, including Content Cache Manager 520, Content Cache 530, and Outbound and Inbound Event Queues 540, 550 and accessing the operating system and hardware sensors, I/O and interface hardware of the Audience App. Content Cache Manager 520 manages the contents of Content Cache 530. Cache Management may be driven by a variety of external and internal conditions and policies, for instance, it may be desirable to limit the amount of storage used by the Content Cache 530. As an example, when an audience member listening to a radio show changes stations (either directly through the Audience App, or as detected by listening to ambient audio), the application logic can instruct Content Cache Manager 520 to reload and/or refresh the Content Cache 530 with the content for the newly-selected show. In an embodiment, Application Logic 510 of the Audience App 500 is responsible for managing inbound and outbound events via the Outbound. Event Queue 540 and the Inbound Event Queue & Cache 550. The following scenario illustrates one simple back and forth interaction through the Audience App 500: Wanting to start a discussion of a timely topic, the Show Host might ask audience members to respond to a poll question, as planned in the Show Prep App and/or Show Management Server. Response options might include “Yes”, “No”, or “Send us a quick comment”. These options would be loaded into the Content Cache 530 by the Content Cache Manager 520, along with instructions and data that would allow that content to be triggered and presented to the audience member when the show starts, or when the audience member manually or automatically selects a live, downloaded, or streamed program to interact with. When the Show Host activates this interactive segment, the Show Management Server is directed to send a message activating this content via Network Hub Server to all instances of Audience App 500 currently identified as being in the audience for that show. This message is then placed in the Inbound Event Queue & Cache 550 of each Audience App 500. The Application Logic 510 uses the metadata associated with the event to determine the appropriate action to take, in this case, presenting the Auxiliary Broadcast Content from the Content Cache 520 corresponding to the poll activity. The poll-related content is then displayed on the Mobile Device 1200. Audience members can decide to respond to the options presented, in this case, we will assume that the member wants to respond with a comment, perhaps by initiating a voice capture recording with a single touch on a “comment” button. The Application Logic 510 will then record the Audience Member's comment, tag it with appropriate metadata (user ID, timestamp, et and place it in the Outbound Event Queue 540 for transmission to the Network Hub Server 300 via Network Interface(s) 560. The Outbound and Inbound Event Queues, in an embodiment, advantageously facilitate rapid delivery and processing of events (and related data, content, and instructions) that must be synchronized with a broadcast program or other time-sensitive events and prioritization of such processing over processing pre-cached content or other content that has been preplanned in the Show Prep App and/or Show Mgt Server. An embodiment of an Audience App is implemented on a mobile device 1200 illustrated in FIG. 12 and described below and uses the native hardware and software resources of such mobile device 1200.

The “Show” referred to here can refer to many different content types and delivery mechanisms, including, but not limited to, any of the following examples: 1) live radio or television shows or programs, 2) a prerecorded program intended for broadcast or streaming at a later date, 3) live streaming audio or video, 4) or on-demand streaming audio and/or video, 5) podcasts, 6) video logs (“vlogs”), or 7) weblogs (“blogs”). In an embodiment, the show may include an audible broadcast signal (for example, radio or TV) that is recorded, preferably using a microphone. In an embodiment, the show may comprise a broadcasted audio signal that is received by the radio frequency receiver of a wireless communications device. In an embodiment, the content of the show may be streamed or otherwise transmitted as digital data and received by a wireless communications device via a wireless communications system. In an embodiment, the content of the show may be streamed or otherwise transmitted as digital data and received by a computing device via any data network or communications system. Note also that the “servers” referenced can be implemented in different embodiments, depending on the desired outcome and environment, may be either collocated in a single location, consolidated onto a smaller number (including one) of physical or logical servers, or distributed across an arbitrary number of virtual or physical computer servers as appropriate for deployment in specific situations.

In general, tasks related to the show's creation, definition, management, production, and distribution are coordinated either directly through the Show Management Server User Interface 210 or through the Show Prep App 100 which in turn synchronizes its data with the Show Management Server 200. Once the show content has been defined and approved for distribution through one of these interfaces by an authorized user, the required content and assets are bundled together as a Content Group to be made available to the Network Hub Server 300 for loading into the content cache of the Audience Apps 500, 500′.

In operation, the invention will be used to provide an enhanced mode of connection and communication across a wide range of participants in the show's ecosystem. Audience members will download the Audience App, which will then prompt the audience member enter basic ID and demographic data that may be in turn be used to facilitate live (real-time or near real-time) audience data analytics. Similarly those involved in the planning, productions, and delivery of the show will also authenticate themselves to the system (actual authentication could happen at any of several places, but will most likely reside on the Show Management Server 200 or Network Hub Server 300), and that ID can be used to determine the user's permissions and allowed abilities within the system.

Although FIG. 1 only shows multiple instances of the Audience App (500 and 500′), a typical embodiment of the system would likely also include multiple simultaneous instances (users) of the Show Prep App 100 as well as possibly the Show Management Server User Interface 210.

Show preparation and operations tasks are performed through either the Show Prep App 100, the Show Management Server Interface 210, or a combination of both. The purpose of these “show prep” functions is to provide a platform that can be used by the show prep staff (which can include producers, on-show talent, coordinators, crews, business office personnel, etc.) to build, share, and exchange content, ideas, ads, schedules, scripts, and other information required to facilitate the production and broadcast or distribution of the show. The Show Prep App 100 is a packaged application (or “app”) designed to be run on a computerized mobile device such as a smartphone, tablet, or personal computer, desktop or portable computer with networking capabilities to allow communication with the other parts of the system. Embodiments of the application can be hosted on a server and accessed via a web browser or equivalent interface. In an embodiment, the networking capability can be based on technologies such as TCP/IP over wired or wireless networks, either Local Area Networks such as “Wi-Fi” or broadband networks such as LTE provided by wireless carriers. Embodiments of the Show Management Server preferably will reside on servers hosted by or for the broadcasters of broadcast shows, including servers hosted remotely or even in “the cloud” to promote easier use by non-broadcast shows such as vlogs or podcasts.

The Show Prep App 100 is one possible User interface for the functions of the Show Management Server 200. As described, and as shown in FIG. 1, the Show Management Server may also have interface, the Show Management Server User Interface 210, which in an embodiment be exposed as a web app. The choice of which interface to use is really a matter of convenience, since both will provide, in an embodiment, similar or materially identical capabilities with respect to the actual mechanics of setting up content and running a show. Certain administrative and configuration activities might only be supported via the direct Show Management Server User Interface, for security reasons, or for functions that require closer coupling and/or interaction with other in-studio or in-station equipment or systems. In an embodiment, the Show Preparation App interfaces directly with the Network Hub Server 300 or a Show Management Server hosted on the Network Hub Server. In another embodiment, the Show Preparation App interfaces indirectly with a Show Management Server via the Network Hub Server. While the relationship between the Show Management Server and the Show Prep App will be, in an embodiment, one of client(app) and Server, that is not always necessarily the case, particularly in the case of remote site events as described above, where some functions of the Show Management Server could be subsumed by the app and handled via direct connections to other system components such as the Network Hub Server, the Social History Server, etc.

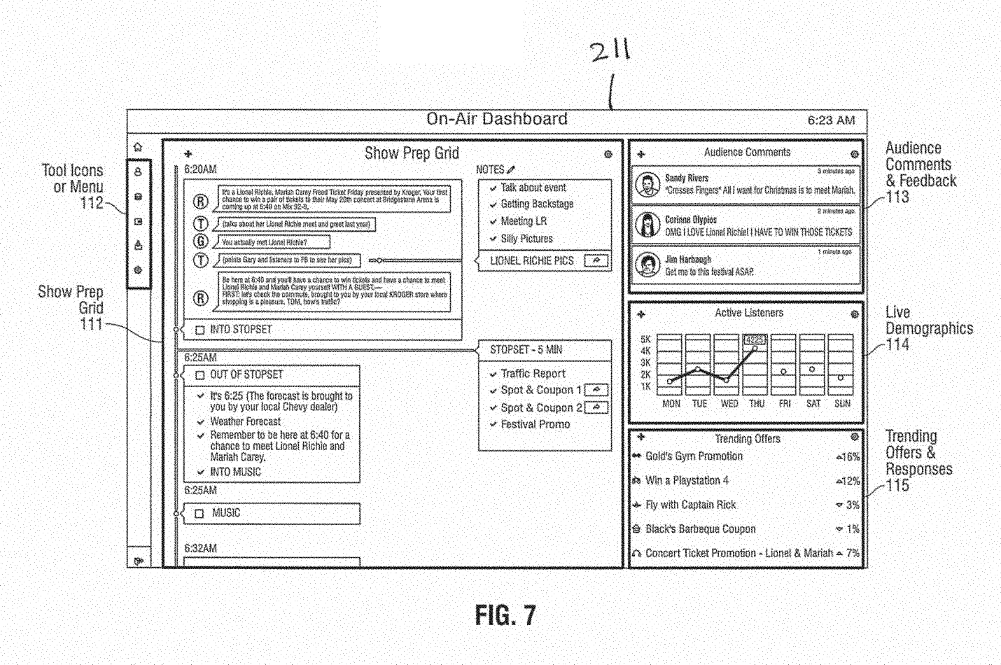

An embodiment of the user interface to the Show Prep App 100 or Show Management Server User Interface 210 in its on-air dashboard mode is the exemplary on-air dashboard graphic user interface 211 shown in FIG. 7. In this embodiment, the Show Prep Grid 111 consumes roughly the left two-thirds of the screen, adjacent to a tools icon dock 112 to the left. The Show Prep Grid 111 is a scrollable area that shows time-marks for segments, pre-recorded program content such as music, notes, outlines of scripts for program talent performers, and “stopsets”, which encompass material interjected at designated points in the show. Stopsets typically include items such as commercials, news, traffic, weather, promotions, etc. In this embodiment, the right-hand portion of on-air dashboard 211 contains additional areas for features such as Audience Comments or Feedback 113, a graph or figures showing Live Demographics 114, and the popularity of several ongoing promotions in the Trending Offers 115. This user interface is likely to be “composable”, that is, built up from modules that can be added, removed, or customized according to needs and preferences by an administrator or the end user of the system's software.

The exemplary content creation and bundling process 405 shown in FIG. 4 includes creating and selecting assets (410), defining grouping and order (420), and publishing approval (430). One or more instances of the Show Prep App 100 and/or the Show Management Server's User Interface 210 are used to assemble information that is required to actually run and manage the show (this includes schedules, stopsets, scripts and/or announcer guidance, advertisements and promotions, etc.) as well as the content that should be made available to the Audience App via Content Groups. A Content Group is a bundle of content and associated assets (schedule and/or ordering and dependency information, audio, video, images, web pages, computer program instructions, effectivity and expiry data, priority and policy, and other metadata) that may be assigned to a particular episode or instance of a show, to a show title in general (making that content group for frequently used shows available without having to re-download that content every time), or to any of a variety of other entities, such as a venue or location, a content channel provider, etc. for transmission to the Audience App. Once complete, the Content Group is marked as ready for distribution to the content cache of the Audience App via the Network Hub Server.

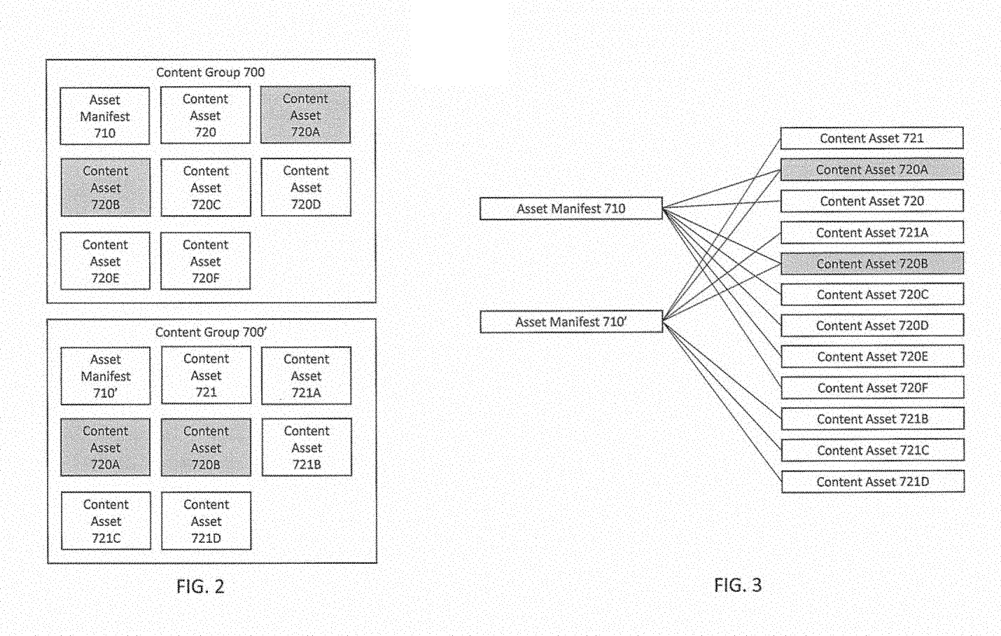

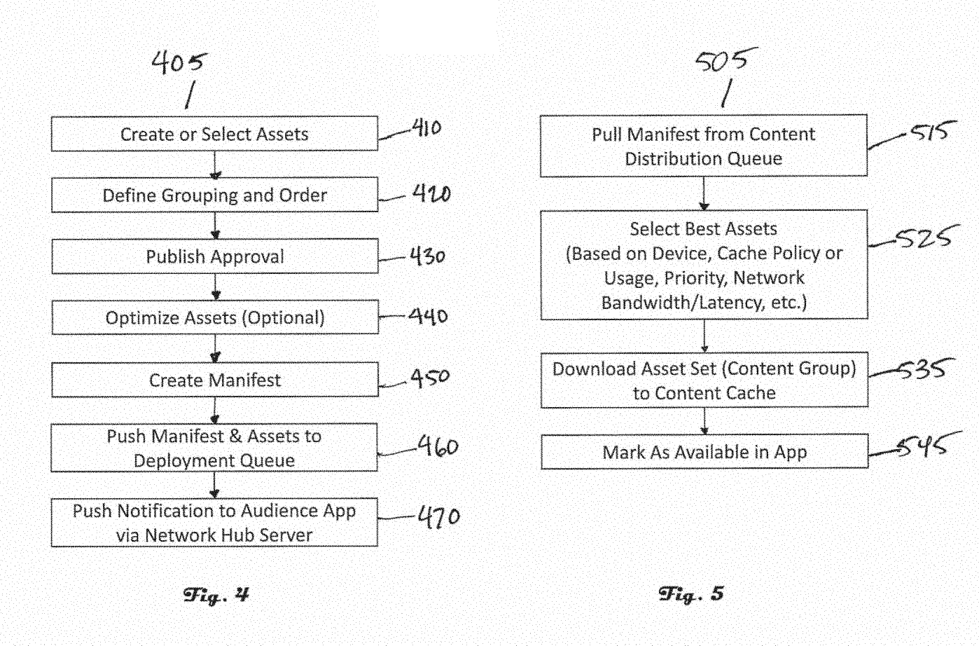

The exemplary content creation and bundling process 405 shown in FIG. 4 also includes optimizing assets (440), creating manifests (450), pushing manifests and assets to a deployment queue (460) and pushing notification to the Audience App (470) Once the information has been defined and approved for distribution, the assets are optionally processed (to pre-optimize for device screen resolution, varying encodings or transcodings, etc.), and as shown in FIGS. 2 and 3, added to one or more Content Groups (700, 700′) as Content Assets 720, 720A-720F, 721, 721A-721F, etc., preferably stored in an Audience App's Content Cache and indexed in one or more Asset Manifests (710, 710′) preferably stored the content cache or application memory for the Audience App. Note that FIG. 2 shows two Content Assets, 720A and 720B, that exist in multiple Content Groups, in this case, Content Group 700 and Content Group 700′. FIG. 3 shows a schematic illustration of the content cache in Audience App 500 (FIGS. 1, 17), showing that even though these Content Assets are required by the Asset Manifests of two different Content Groups, only one copy of these Content Assets is kept in the cache. This de-duplication of the cache in the Audience App is based on unique identifiers, content check summing and/or “fingerprinting” and/or other techniques well-known in the art for managing and optimizing distributed information caches.

Effectivity and expiry settings (most commonly expressed as a Unix “Epoch time” or ISO 8601 or RFC 3339 “datetime”, e.g., content effective as of “2018-01-08 10:00:00Z”, and expiring “2018-01-12 13:00:00Z”) and policy (regarding things such as retention and overwrites) can be determined through the Show Management Server User Interface 210, the Show Prep App 100, or another tool designed to allow configuration of network content policy. In most cases, this information will be automatically set based on the policy settings of the system. Such effectivity and expiry metadata are generally communicated along with the content assets, either by tagging them directly, or keeping them in a lookup table or database, which could include the Asset Manifest. Note that it is possible for Content Assets to have their expiry datetimes updated by content distributions that take place subsequent to the initial distribution that resulted in that Content Asset being loaded into the Content Cache. In such a case, the expiry date of an asset may be updated to reflect that some program has requested that it remain cached for a longer time. As is usual in local management of caches of limited size, policy defined by the servers is usually interpreted as a suggestion, and local policy may override it (for instance, in an environment in which storage is limited, by refusing to cache large assets (forcing them to be instead downloaded on-demand only when needed) or purging large items (such as video clips) after use to minimize the impact on local storage of the Audience App device.)

FIG. 5 illustrates an embodiment of an exemplary process 505 to transfer information and Content Groups that have been marked as available to the cache of an Audience App. Note that the Audience App may dynamically select the most appropriately optimized assets based on the capabilities of the local hardware and software device running the app, cache policy (for instance smaller video clips may be preferable if only a small amount of cache space is available), the priority of the asset and or Content Group (for example, Content Groups marked as “Emergency Information” or “Official Emergency Information” would take priority over others), and network concerns such as bandwidth availability, stability, and latency.

The exemplary process 505 shown in FIG. 5 includes pulling a manifest from the content distribution queue (515), selecting best or optimal assets (525), downloading or pushing the asset set or Content Group to the Content Cache of an audience app (535) and identifying or marking the asset set or Content Group as available (545). The Audience App 500 contacts the Network Hub Server 300 with a message containing information identifying the show that the audience member is consuming. A manifest for that show ID is then downloaded, and a set of assets is selected by the Application Logic 510 (see FIG. 17) of the Audience App 500 and the Content Cache Manager 520. The set of assets selected may be influenced by the storage and compute capabilities of the Mobile Device running the Audience App 500, a set predetermined static or dynamically altered policies reflecting cache usage, priorities, network quality available (including bandwidth, latency, reliability/stability, mobility, etc.) and other factors. (For instance a mobile device running the Audience App with a large amount of memory and a high-resolution screen might load a higher-resolution version of a video clip into its cache, while a more limited mobile device might choose to download a lower resolution version of the same clip from the manifest instead. Once the content assets making up an asset set is confirmed to be available in the Content Cache 530 for use by the Content Cache Manager 520, the Application Logic 510 is notified that the asset set is available for use and activation by an event notification.

Note that event notifications such as those described above, and even the distribution of the program content stream itself, may optionally take advantage of multicast and/or broadcast capabilities of the data and wireless networks connecting the Audience App devices, if such capabilities are available. In most cases, such optimization requires higher-level interfaces to and with the wireless carriers' networks. Also note that such capability to broadcast or multicast data could additionally be used to minimize the network impact of live-streaming the program content itself “in-band” over the data and wireless networks connecting the Audience App devices.

Since, each user (audience member, in this case) preferably has a uniquely identified account, or identification information associated with an Audience App, the system has the ability to generate a live (real time or near real time) report of the demographics of the audience. Such information can be used by the show's producer, program director, on-air talent, etc. to know, for instance, how many men or women are tuned in at any moment to allow them to better tailor the content for the audience. (This might, for instance, take the form of rearranging show segments to move a segment with a more female-skewed interest up in the schedule to take advantage of an advantageous proportion of live female listeners) Such demographic adaptation can be driven using both information supplied in surveys and signup forms as well as information gleaned through the audience member's interaction with the system, other participants, and other online resources over time. In an embodiment, the Audience App can collect demographic information from a user by generic queries, or program-specific queries, and this demographic information can be transmitted by the Audience App to the Network Hub server and from there transmitted to Show Management Server and/or Social History Server for persistent storage (e.g., in a database associated with the server and use in connection with broadcast programming.

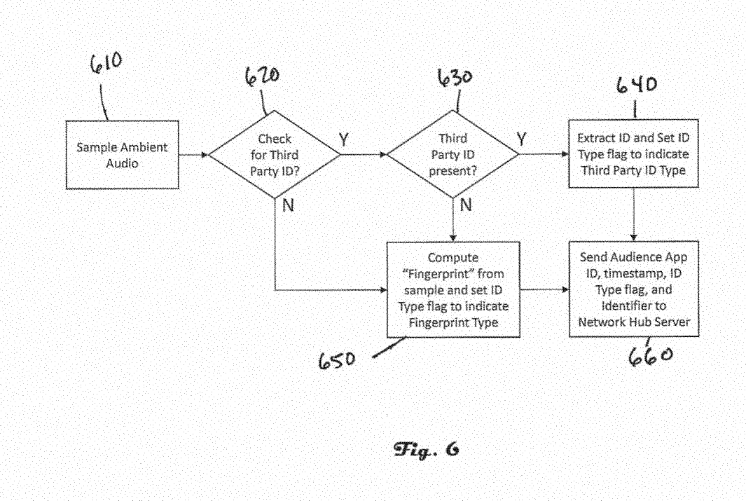

In order for the system o be able to correctly match an audience member with the appropriate show (especially important for live broadcasts), it is necessary to know what show that audience member is listening to. Three exemplary methods of accomplishing this are described below. A possible embodiment of the latter two methods are also illustrated (for audio, similar methods may be used for video) in FIG. 6.

In one exemplary method, the audience member simply selects the show or program they wish to follow or interact with via the user interface of the Audience App. Once the app is active, this selection may be made in any of a number of ways well-known in the art, for example via menu picks, full or partial typing of text and selection from a list, voice commands, simply touching the screen by using a “big touch” mode making the predicted selection(s) made easier to select, use of a history list, etc. Once a show is selected, the Audience App will forward unique identifiers for the Audience App and the selected show program to the Network Hub Server for processing and distribution or forwarding as required and the user interface on the Audience App will default to interactions with that show until either the audience member changes the selection, or the show ends or is replaced by another. (This latter feature is particularly valuable for live broadcasts or streams.)

In a second exemplary method illustrated in FIG. 6, the Audience App samples or “listens in” on the ambient audio environment (610) for an embedded station or broadcaster identifier code (620). (In the case of video streaming, the identifier may be embedded in the video or metadata portions of the stream in addition to, or instead of, being embedded in the audio stream.) This identifier code may be either one of the standard ones frequently injected into broadcast signals for audience tracking (for example, the embedded audio identifiers used by the Neilsen/Arbitron Portable People Meter to determine station ratings, or identifiers inserted per the proposed ATSC 3.0 standard), or another one that is specifically injected into the program stream by and/or for this system. In the latter case, the overlay of the identification signal on the program content stream could be performed by the Show Management Server or an external processor specifically intended for this type of identifying signal injection. Once the Audience App has recognized and extracted a known type of identifier (630, 640) (as described above, the system may be capable of capturing and identifying several different types of identifying markers in the program), it sends the station or broadcast identifier code, its type, a timestamp, and the Audience App ID (660) to the Network Hub Server for processing and forwarding of updated information.

In a third exemplary method, shown in FIG. 6 as step 650, the Audience App listens to the audio of the show and creates a tokenized representation or “fingerprint” of the audio stream. This fingerprint is designed to identify a portion of a content stream unambiguously enough that it can be matched to another similar fingerprint derived by another system and thereby identify (from the fingerprint) the station or broadcast identifier code, which is then transmitted to the Network Hub Server (660).

The Audience App in an embodiment is capable of supporting several different types of audio fingerprinting simultaneously, as some will tend to perform better in some ambient audio environment circumstances (such as with background noise from a moving vehicle) than others. Similar audio fingerprint technology already known to the art has been used to identify songs and other audio in popular applications such as Shazam®, SoundHound®, and Pandora's Music Genome Project®. Note that some of these systems are generally aimed at creating fingerprints for audio of a fixed length, and may not necessarily gracefully handle fingerprinting small sections of continuous audio streams of indefinite length, such as those common to broadcast environments.

The audience app preferably is implemented on a mobile device or mobile wireless computing device comprising, a processor, a memory, and a microphone. The microphone is activated to record one or more audio samples of a show. The sample is processed and stored as signal data in memory of the mobile wireless computing device. In an embodiment, the mobile wireless computing device comprises a radio frequency receiver and an antenna, which in an embodiment includes a headphone jack and wired headphones, and one or more audio samples of a show are received via the radio frequency receiver. In another embodiment, one or more audio samples of a show are received in digital format as data or streamed data. The processor then executes code for an audio fingerprinting algorithm (also stored in memory) to create a token, fingerprint, or audio signature of the audio sample. Audio stream fingerprinting algorithms are known to those of skill in the art. An exemplary open source implementation of continuous audio stream fingerprinting, which could be used by the Audience App to automatically identify the program or show can be found at: https://github.com/dest4/stream-audio-fingerprint. Another exemplary open source implementation implementing audio stream fingerprinting and recognition, in Python: https://github.com/worldveil/dejavu.

Once a fingerprint of the audio has been created, it is forwarded to the Network Hub Server for forwarding to other nodes in the system that need this information. In one preferred embodiment, the Audience App would periodically forward the thumbprint of its ambient audio environment, along with a unique identifier, a “datetime” timestamp, and optionally location coordinates and other data and/or metadata, to the Network Hub Server, which would match the submitted fingerprint with one of the known fingerprints provided by the Audio Fingerprint Servers relevant to the location of the Audience App. Once a match is made, the Network Hub Server may optionally forward this information to other systems or servers (for example, the Show Management Server) for use. In the event that the raw feed of live subscribers is too large an amount of information (as could be the case with a very large audience), the Network Hub Server may, as determined by its policy configuration, opt to forward summary information instead of a complete record or report of the audience, particularly in the case of summarized live demographic data.

FIG. 1 shows that a stream of the audio program content (Program Stream Content 800) may be fed directly into the Show Management Server 200 (which can in turn inject an identity signal into the original program content stream—this may be particularly valuable if the stream is to be made available for digital delivery to the audience through the Network Hub Server or another Internet or other digital streaming facility), or into an Audio Fingerprint Server 600 to support stream identification and synchronization of recent fingerprints of the stream with the Network Hub Server. To have a set of valid audio fingerprints to match with the fingerprints collected by remote instances of the Audience App, it is desirable in an embodiment to continuously or continually at short intervals generate the fingerprints of live streams for comparison.

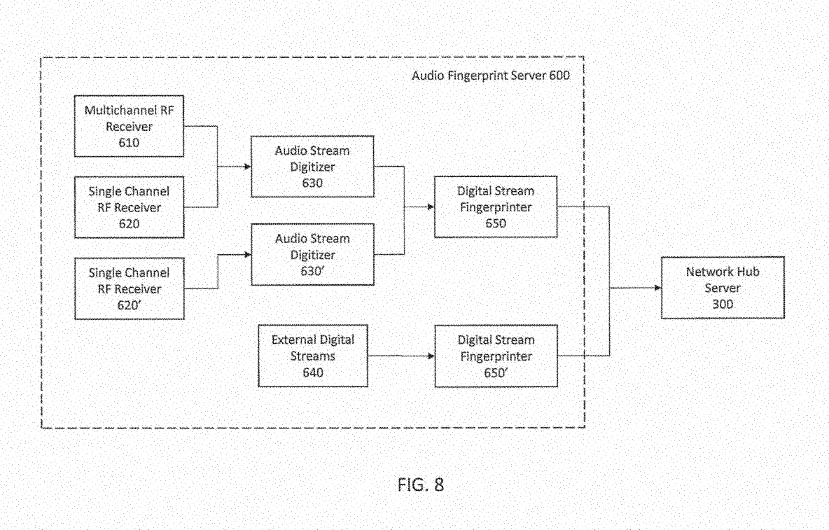

Audio Fingerprint Server 600, illustrated in FIG. 8, may be used to generate audio fingerprints for one or more audio streams. If an Audio Fingerprint Server is in place in a particular market, it too can listen to a broadcasted program (via RF receiver or online stream processing) and produce fingerprints for that content stream, store the fingerprints for future use. (In an embodiment this can be based on the insertion of a Neilsen-like token, or fingerprinting the content stream without signal injection.) These streams may be delivered to or received by Audio Fingerprint Server 600 by direct digital streaming over a network, or they may be captured from audio feeds, including audio feeds from one of more receivers. As shown in FIG. 8, it may be beneficial, especially in urban areas with many stations, to set up a “listening post” consisting of one or more sets of receivers, such as Multichannel RF Receiver 610, or Single Channel RF Receivers 620 and 620′ feeding analog audio streams into an Audio Stream Digitizer 630, 630′ which then forwards the digital audio stream to be fingerprinted to a Digital Stream Fingerprinter 650. Digital streams from external (network or local or remote digital receiver) sources, shown as External Digital Streams 640 may also be fingerprinted as shown in the case of FIG. 8, by Digital Stream Fingerprinters 650, 650′. The Audio Fingerprint Server transmits the digital stream fingerprint data to a Network Hub Server 300, and frequently updates the recent fingerprints of the relevant streams for matching, for example in a fast hashed key-value type of data store or database to facilitate rapid lookups. This will allow fingerprint matching of any broadcast audio stream in the reception area of the receivers (which, it is important to note, may be remote), allowing incremental value to be generated from the demographic audience information data collected as a byproduct, even if there is no interactive content available on those shows or broadcast channels. (That is, even if third-party broadcasters do not participate in any of the interactivity features of embodiments of the present invention, the Audience App will still be able to capture and measure at least some times when an audience member is in the presence of these broadcasters' programs.) The Audience Computing Device can then monitor its ambient environment and produce fingerprints of its own, which can then optionally be matched up by the system once both fingerprints have been reported back through the Network Hub Server(s). In addition, if a show is rebroadcast so that it is time-shifted to other time zones, the Network Hub Server could either rely upon live feeds as usual for fingerprinting, or may keep a cached copy of the fingerprints from the earlier broadcast for comparison with the fingerprints submitted by the Audience Apps.

FIG. 16 illustrates an embodiment in which the system of servers described herein can be used to support a live show broadcast across multiple geographic areas. In the example illustrated in FIG. 16, the show originates and is managed in Metropolitan Area No. 1 (1610). Show Management Server 200 may reside in Metropolitan Area No. 1 (1610). The Social History Server 400 provides a common connecting service to all of the show's audience, so it may be located anywhere (perhaps in the cloud, in this event), but contains the social environment for all of the show's audience, regardless of location. Functions that need to be performed locally are distributed and replicated across geographic areas. For instance, Network Hub Server 300′ serves Metropolitan Area No. 2 (1620) and coordinates with its counterpart at the show's origin, Network Hub Server 300, as well as with the Show Management Server 200 and the Social History Server 400. Audio Fingerprint Servers 600 and 600′ are also replicated to allow fingerprints to be correctly collected and reported in both cities. (This distribution and replication is especially important in fingerprinting broadcast signals across multiple locations.) Note that Audience members in each metropolitan area may see both locally targeted content as well as regionally or globally targeted content, depending on the policies implemented by the Show Management Server 200. In alternative embodiments, all or any of the servers illustrated in FIG. 16 may be located or hosted in Metropolitan Areas 1 or 2 (1610, 1620) or in the cloud or in one or more remote locations, accessible via WAN.

In an embodiment, audience members, through the Audience App, may signal their willingness to be included not just as a passive recipients of the show's program feed, but at their option, also s an active live participant. In an embodiment, audience members who have signaled their willingness and readiness to participate in the show in this way could be directly reached out to (individually, or as a group) by show staff in a “virtual call” originated by the show staff without today's hassles of asking them to call in. Optionally, if the device platform allows and the device has telephone capabilities, the Audience App could connect a call “out of band” via a telephone call, VoIP connection, or the like, to a called phone number that has been sent specifically sent to or configured in that device. Further, since this is a requested call, the system can also instruct the telephone system at the show's station or studio to only accept calls from a particular known phone number (the number from which a call is expected) on the specific target line that is being targeted for use by a specific audience member. When a call comes in from a number other than the expected one, the system might answer and either instantly hang up, or very quickly transfer or forward such a call to another number or extension for playback of a message (intended for a human and/or encoded for a machine such as the Audience App) indicating that the number called can only connect when activated by the show staff. This allows the relevant direct inward dial telephone number to remain free and open for the intended caller and prevents reuse of the incoming number by any phone number other than that of the intended audience member. Since the audience members' profile information will be known, live show talent could address the virtual caller directly by name and city.

The ability to pre-load content into the Audience Apps for a variety of circumstances allows the Audience App itself to become an additional channel for the delivery of auxiliary program content, data and instructions to augment the primary channel (broadcast, web, etc.) This capability can allow “guided” interactivity and synchronized delivery of this auxiliary content alongside the primary program content. One example of this might be the ability to add visual interaction and content to traditionally audio-only media such as radio. For instance, in promoting a new truck model, a content group might be defined that consists of, say, photos of the interior and exterior of the featured truck, a short video clip of the truck in action, a page with details of the current promotion and contact information, and a map (or ability to launch a map on the Audience App device) to the advertising dealer. As the show host reads or talks through the advertisement's script or content, he or she can activate each of these content assets at the appropriate time through the User Interfaces of the Show Prep App or Show Management Server. In an embodiment, the activation instructions will be transmitted to the Network Hub Server for transmission to Audience Apps listening to or otherwise interacting with the primary broadcast program. To further continue this example, the script might involve mentioning the good looks of the truck, along with the live activation of the exterior photo (or a short slideshow of multiple exterior photos), then mentioning the innovative interior of the truck, with activation of that photo or photos, then a mention of the current specials and the dealer's name accompanied by activation of one or more content pages containing deals and contact information. This latter page might in turn contain internal links to the other pre-cached content, the short video clip and the map to the dealership, or even external links to resources available via the Network Hub Server (say, longer videos that could be streamed on demand, or placing a call or opening a live chat session), or links to virtually any other kind of external web and other network-connected resources. In an embodiment, the Audience App may include data or instructions, either pre-cached or received from the Network Hub Server, to display pre-cached or downloaded content at a specified time corresponding to content in the primary broadcast program. The auxiliary content in the Audience App may include data and instructions instructing the Audience App to display pre-cached or downloaded content at a specific time of day (say, 10:10 am, local time), or at a specified time interval relative to other program content, data, or instructions, including timestamp and/or offset data and instructions. Consider, for example, an on-demand or other prerecorded program such as a podcast or a video downloaded from Google's Youtube® platform. Auxiliary content related to this type of content could include data and instructions to display (on the Audience App) specified content at specified time intervals relative to the beginning of the program. Further, the Audience App can include provide user input prompts at specified time intervals during the transmission of the prerecorded program to collect user feedback to transmit to the Network Hub server for consumption by the show producers.

Almost any content shared via the embodiments described here can also be made “social”, which, if enabled, gives audience members the ability to respond with ratings, comments, and sharing of information presented in near real time. As with most other functions of the Audience App, this kind of social engagement may be made largely or even entirely via voice, to minimize the need to touch and interact with the device running the Audience App, with such comments optionally being added to the Show's (as well as the Audience Member's) timeline in a way similar to other social networks. If desired, the show owner could optionally even allow their social interaction space to continue to operate and allow audience participation even beyond the time bounds of the show. This can promote the formation and support of more heavily involved and invested audience communities that can grow and interact beyond their usual limits.

This ability of the invention to directly interact with audience members in a live manner can also be used to capture audio or textual call-in queue information for virtual call screening. In one example of such a process, a radio show host might want a voice clip from a user to set up say, a concert ticket giveaway. In preparation, the show's host or production staff would have prepared Content to solicit such an audio clip previously in the Show Prep App or Show Management Server User Interface. In an embodiment, “generic” content templates could also be resident in the Audience App to handle various kinds of common requests or interactions. These templates could then be prepared and quickly customized with the desired message in the event that a specific request has not been prepared and distributed ahead of time. For example, generic poll content elements and instructions would be pre-loaded in the content cache, but the poll question itself and the responses and response types (radio button, multiple choice, or text entry/voice capture)could be reconfigured on the fly to accommodate interactivity that may not have been originally planned as part of the show. Shortly before the clip is needed, the show's host or production staff can activate this content within its listener's Audience Apps. At this time, the preprogrammed action would be performed and/or the preprogrammed content would be displayed and/or played or otherwise activated.

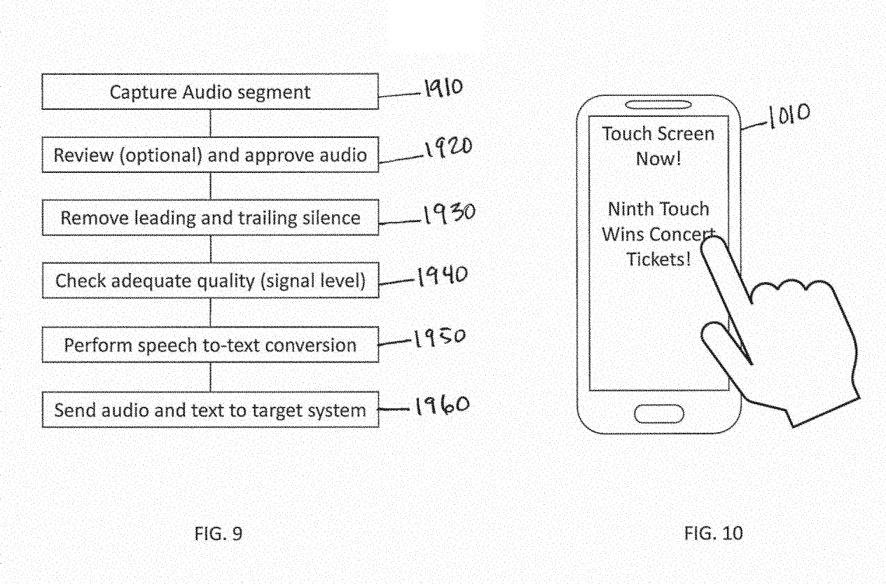

As an example, the Audience App might “pop” an input screen to its audience members requesting them to record the phrase, “Hey, Rick, when are you going to be giving away those Spinal Tap tickets?” along with audio recorder controls to record, check, and send the recorded audio. Audience members wanting to participate could then quickly record and send their responses. Once such an audio clip response is submitted, the Audience App optionally performs audio clip processing (for example as shown in FIG. 9) and sends it to the Network Hub Server. Note that the various processing steps for audio clip capture shown in FIG. 9 (capture an audio segment (1910), review (optional) and approve audio (1920), remove leading and trailing silence, dead space, noise, and other non-verbal content (1930), evaluate the quality and signal level of the audio sample (1940), perform speech-to-text conversion (1950), and send the audio signal and the corresponding text to the target system (1960)) can be performed using conventional tools and methods known to those of skill in the art and may be performed by different systems in the process depending on the configuration and even the capabilities of the various system components. For instance, a more limited Audience App device might only capture the audio clip and send it to the Network Hub Server, for forwarding to the Show Management Server, and one of these two latter systems would perform subsequent audio processing such as removal of leading and trailing silence and speech-to-text conversion, while a more powerful Audience App device might perform most or all of the processing locally. Once the audio clip and corresponding speech-to-text transcription are available, they can be made available on the User Interfaces for the Show Prep App and/or Show Management Server. The text transcription allows the show personnel to ensure that the clip is indeed what was requested, and then play it on the air, even using other known information to introduce the audio clip as if it were from a live call: “Donna from Austin just asked”, followed by playing Donna's recording of the captured audio clip, “Hey, Rick, when are you going to be giving away those Spinal Tap tickets?” This playback could be initiated through either the Show Prep App or the Show Management Server User Interface, resulting in feeding the audio “clip” (in either analog or digital form as appropriate), into an interface for actual program content.

Yet another example of closed loop interactivity value would be as a replacement for dial-in telephone calls for contests and promotions—the familiar “Ninth caller wins . . . ” of live radio shows. In this case, if Content Assets have been defined for promotional giveaway, then these may be displayed when the appropriate sync trigger is sent to the Audience Apps via the Show Management Server and. Network Hub Server. A typical scenario might be as follows: As announcing that, “Ninth touch wins concert tickets”, the show host activates (via the Show Prep App or Show Management Server User Interface) a predefined “touch to win” Content Group in the Audience App for that show; the Audience App would then go into a mode allowing most or all of the screen to be touched anywhere to activate a response, as illustrated in FIG. 10. The Network Hub Server will collect and order responses from the Audience Apps, delivering the profile of the ninth touch received to the User interface of the Show Management Server or the Show Prep App. This audience member can then be directly connected into the show via in-band (network.) audio via the Audience App or out-of-band via a telephone call to talk about the winning prize and/or promotion. In addition, non-winning audience members can still receive a coupon or other alternate prize or promotional item delivered digitally (in an embodiment, via the audience members timeline), something that is not possible with today's phone-in systems.

Additionally, variations can be introduced into the interactivity which might carry special significance. For instance, a show soliciting donations for disaster support might activate a Content Group on the Audience App that allows audience members to easily and quickly make a donation to a cause they find worthy. An example of one preferred mode of the Network Hub Server's functionality in such a scenario is a radio station soliciting donations for aid to those affected by a natural disaster, say a recent hurricane. This scenario may assume that the Audience member has defined a payment method when signing up, an action that may be either required or optional depending on the desired properties of the system and preferred business model. The show host has prepared a Content Group for this segment of the show and approved it for distribution before the start of the show. In general (each specific case is governed by the stackup of policies) this content would be distributed to all who might be expected to possibly interact with it, including live listeners of the show and perhaps even regular listeners of the show, even if they may not be tuned in and listening yet. When the time comes to activate this segment, it will show on the Show Prep Grid area of the screen on either the Show Prep App or Show Management Server Interface. In this example, there are six photos to be shared as part of the segment. After “opening” the Content Group for this segment, the host can “pop” each of these in any order to cause them to be displayed in the Audience App by a conventional user interface action such as pointing, tapping, double-clicking or double-tapping, dragging and dropping, etc. In addition to the photos in the Content Group, the Asset Manifest for this group would contain a special predefined touch action content asset. After having showed and talked about the photos demonstrating the need for assistance, the host can activate the special touch action asset to allow audience members to easily and quickly make a donation, for instance, the host might activate the “Touch to give Five Dollars” asset, and tell the audience that they can, “Touch your screen once to donate five dollars, twice to donate ten dollars, up to six times to donate thirty dollars.” The touch events will be sent to the Input Queue of the Network Hub Server and collated and counted. Note that in a case such as this, where a response event has a financial cost, there will typically be at least one level of confirmation and approval, and possibly more. For instance, the Network Hub Server could increment a counter based on the received donation touch events for each responding audience member, and after a delay to allow responses to flow in, could initiate two confirming actions, one a mechanical check with the individual Audience App to ensure they have the same touch count, and once the correct count is agreed upon, a second manual confirmation and/or approval screen where the audience member confirms the donation. As with all other interactions with the system, this interaction will insert an event in the audience member's “timeline” stored on the Social History Server 400 for future reference and optional social sharing and/or publication.

In an embodiment there is a “stackup” of policies, some set by the Show personnel, some set by the audience member, and others, for instance, by the Audience App itself depending on its local environment and circumstances. One example might be that the Show's staff might request the preloading of a video clip, but limited storage capacity on the audience app's local device can cause it to refuse that request to pre-cache that content—this might, in turn, cause that content to simply be streamed if and when the audience member requests it. These policies need to be somewhat fluid and variable to ensure that “the ‘most right’ thing happens” in varying environments—in addition to device-local considerations, a wide variety of other environmental circumstances can also affect the actual actions, including limited network bandwidth or latency, general poor reliability or connection stability at a crowded venue, etc.

Another exemplary feature of an embodiment is a social network-like “timeline” to capture and make available each audience member's interactions with the system, or even with others within a virtual community. For example, in the “Ninth touch wins” example, a link to information on how to claim tickets might be placed in the winner's Timeline, while a link to the coupon would be placed in the Timelines of audience members who responded with a touch, but were not the winning ninth touch. The Timeline also tracks items, including advertisements, that the audience member encounters in the course of being exposed to programming across multiple shows and/or communities.

At any time, an Audience member can easily place a marker or bookmark on their timeline to aid in recovering or reengaging with content they just heard or viewed. This could be used, for instance, to save a marker for an advertisement, offer, or other information of particular interest to the audience member. Today, commercial broadcast stations in particular have to rely on very awkward and “non-sticky” methods to hopefully, but often in vain, urge the audience member to remember one or more critical pieces of information required to act on an advertisement or promotion, typically things like the advertiser's business name, phone number, and/or URL. In embodiments of the present invention, because the Show Management Server and Show Prep Apps define or can track things like which ads run when (and may optionally interface with existing ad placement and injection systems, if present), an audience member could either insert a marker in their timeline (which would make note of the show and its content around that time for later lookup), or simply search for the ad that was on at a particular time. (If the Audience App was active and either “tuned in” to a show, channel, or station or able to actively identify the show channel or station via audio ID as indicated above, it is not even necessary for the audience member to specify where to look for the ad in question, since the source will already be known.) This capability can enhance the value of advertisements for shows that use embodiments of the present invention, since the Audience Member can easily find a particular ad of interest that was encountered in the past, and if available, listen to it or watch it again, or even forward it via email or other electronic means.

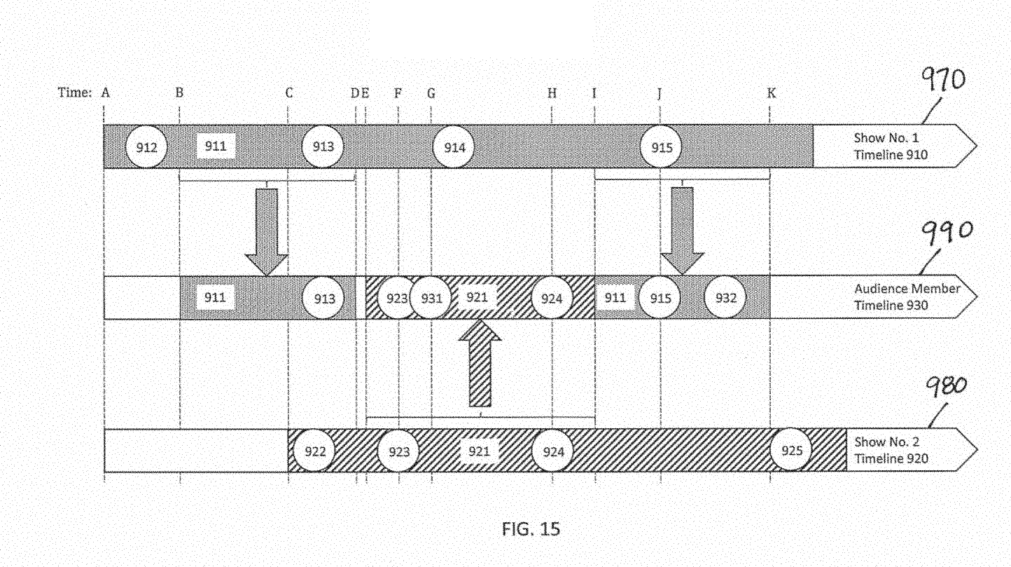

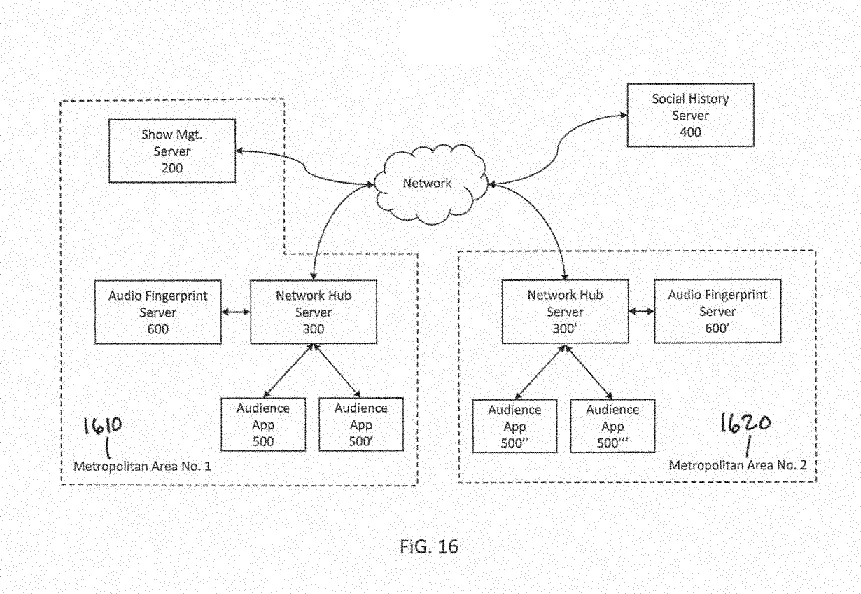

Although superficially similar to some common types of social network timelines, the timeline capabilities of embodiments of the present invention offer some important additional capabilities. A simple diagram showing a few of the possible features of the timeline is illustrated in FIG. 15. In this example, three timelines are illustrated: The top and bottom timelines 970, 980 represent the timeline of two independent shows, called “Show No. 1” and “Show No. 2” respectively. The middle Audience Member Timeline 990 represents the timeline of one particular audience member. At the top of the diagram is a row of time indices, starting at Time A and proceeding through to Time K. Show No. 1 911 begins at Time A and Show No. 2 921 begins at Time C. Show No. 1 is represented by a dot pattern in the diagram, while Show No. 2 is represented by diagonal hatching. Both shows run beyond Time K in this diagram. Each show also has a number of illustrated Content Markers (912-915, and 922-925, respectively) that may represent any of a wide variety of types of content that may be indexed to a timeline. Such Content Markers may comprise or designate either content that is in the primary program stream or secondary and/or auxiliary content such as show audio, video, advertisements or promotional segments, entertainment bits used by on-air personalities, user contributions such as, but not limited to, photographs or images, audio, video, audience phone calls or other live interaction, touch response conversations (in either voice/video and/or text form), in-studio guests, all broadcast or over-the-air ad content, events (including events such as entering or exiting an audience or timestamped audio fingerprint records) and other content such as delivered interactive web pages or links to other resources available via the Internet or other network.

Although audience members can insert markers or reminders into their own timelines, much of the construction of timelines is automatic, based on the knowledge of what programs the audience member is consuming, interacting with, or perhaps merely in the presence of at a particular time and place. For the purposes of this example, it is assumed that the audience member is listening to a radio program in his car: The timeline of the audience member illustrated in FIG. 15 shows the following activity in several time intervals, with the audience member tuning in to Show No. 1 at Time A, ending that listening by Time D, tuning in to Show No. 2 at Time E, and listening until Time J, at which point the audience member switches stations back to Show No. 1 and listens until Time K. In this example, the gap between Time D and Time E might be a quick stop for coffee on a morning commute, and Time K could well correspond to the audience member arriving at the destination.

Note that the Audience Member Timeline 990 inherits a substantial portion of its content from other timelines, in this case, Show No. 1 Timeline 970 and Show No. 2 Timeline 980, as shown by the dotted or diagonally hashed arrows in FIG. 15, (Also keep in mind that this example is greatly simplified in reality, there will likely be many more possible timelines than can be easily shown on a one page diagram—in addition to each individual show or program, there may well be additional timelines for broadcast stations or show or program sources, media or event types or categories, etc.) In the interval from Time B to Time D, the Audience Member Timeline 990 inherits all its content from the Show No. 1 Timeline 970, including Content Marker 913, which as described above might represent a wide range of content, but in this case could be the advertisements featured during a commercial break, or perhaps a link to an item of local community interest. At some time after the audience member has tuned in to Show No. 2 at Time E, the host of Show No. 2 initiates a giveaway of, say, concert tickets—this is represented by the Content Marker 923, which originates on Show No. 2 Timeline 980, and is thus inherited by Audience Member Timeline 990. In this case, though, the audience member elects to respond, and so a new Content Marker 931 is inserted into his timeline. If the audience member's entry was the winning one, then this marker could encapsulate information on how to pick up the tickets he won at will-call, or if not a winning entry, could contain a link to a secondary prize, perhaps a discount coupon for downloading the concert artist's latest song. Note that the timeline illustrations in FIG. 15 are shown mostly from the audience member's point of view—the station or show might have markers for all contest respondents on its own timeline, which would not be visible to others, just as each audience member's timeline may be visible only to that individual audience member. In general, visibility of various kinds of events and markers is determined in a role-based manner, for instance, with personnel running a show having differing visibility from audience members, or advertisers.

In like fashion, the Content Marker 924 is inherited from Show No. 2 Timeline 980. At Time the audience member switches back to Show No. 1. Content Marker 915 is automatically inserted (inherited) from Show No. 1 Timeline 970, but the audience member may have elected to manually insert Content Marker 932 into his timeline to more easily find a reference to an item in the program content of particular or interest. Note that it is possible to arch many different timelines, and to use timelines, stations, shows, or other categorization to scope searches for desired content, even if there is no explicit marker for it in the audience member's own personal timeline. As an example, the audience member may only have been told by a family member that they had heard an ad for a desired service, say tree pruning, on a particular time or during a particular program “last Thursday”. The timeline search feature can index all advertisements by content using either explicitly created metadata, or via text-to-speech conversion, allowing the ad to be found by searching for an advertisement for tree pruning service last Thursday. If the roles were reversed and the audience member manually places Content Marker 932 into his timeline, knowing that his sister needs tree pruning, he can easily share the marker directly with her, either through her own timeline if she is also a user of the system, or via some other system such as email, text message, or even another third party social network.

In some cases, Content Markers, like distributed Content Elements themselves, may have effectivity and expiry dates associated with them. This would allow the automatic expiration and removal of a time-limited resource such as a coupon from an audience member's timeline, even if they had manually inserted a marker to the resource, (The marker could optionally remain in the timeline, but be redefined to redirect the audience member to an expiration notification page, in the event that access to an expired resource is attempted.) Timeline history and content are created, updated, stored, and made available to other elements of the system by the Social History Server(s) 400, often via the Network Hub Server(s) 300.

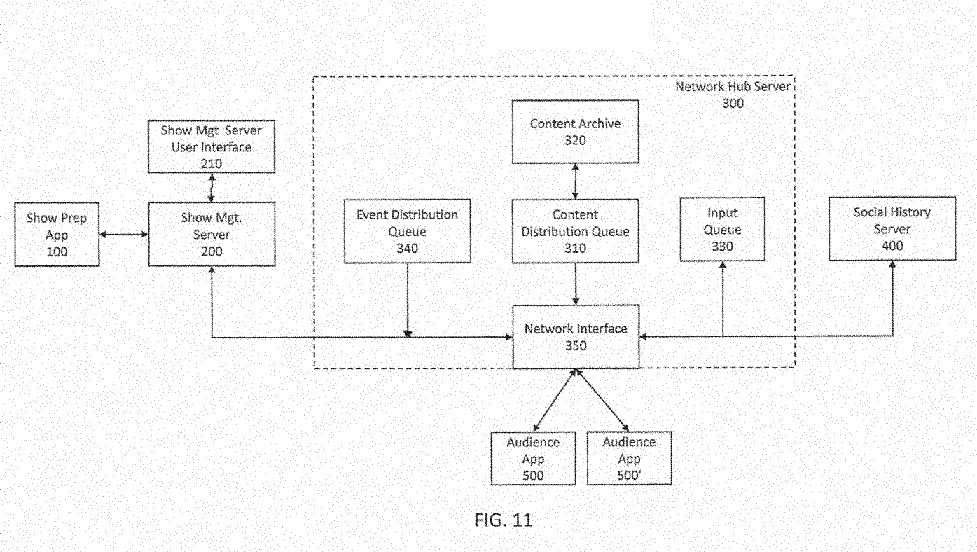

As apparent in the preceding examples, in some embodiments the Network Hub Server 300 plays a large and important role in the operation of the system. FIG. 11 illustrates an embodiment of the internal architecture of the Network Hub Server 300, as encompassed by the broken-line box. In this embodiment, all of the primary interfaces to the Network Hub Server are made via the Network Interface 350. Although only one such interface is shown in this example, real-world considerations such as traffic management, load balancing, and redundancy and fault tolerance may make duplication of this or any other system component desirable. The Network Hub Server is responsible for collecting and distributing nearly all of the communications between the various other major system components as illustrated in FIG. 1. In operation, it will collect and distribute events from the Audience App and content to and from the network-connected Audience Apps, as well as collect, collate, and forward events in both directions between the other “backend” system components (Show Management Server 200, Social History Server 400, Audio Fingerprint Server 600, etc. and the remote components. The Network Hub, in an embodiment, ensures delivery of two different kinds of things. There is a slower mode intended to be used for things like distributing the show-related content and other information that is less time-sensitive or there is plenty of time to distribute the content. Another mode is primarily intended to handle events in a more urgent or timely fashion. Event notifications, for example, can be moving in either direction and/or between almost any components of the entire system. In practice inbound and outbound events may be handled fairly differently which is why FIG. 11 shows queues 340 and 330 in addition to a content distribution queue 310. “Remote” components are primarily the large number of instances of the Audience App 500, but may also include other components or systems, including in particular the Show Prep App 100. In ordinary operation, the Show Prep App 100 communicates directly with the Show Management Server, but it is capable of running entirely via the Network Hub Server for example, when used in remotely produced (on-location, etc.) events for the show.

In the case of content to be distributed, the Network Hub Server will receive a Content Group 700 package from Show Management Server 200, and after optionally providing additional processing, make the content available for download by the Audience Apps 500. In one preferred embodiment, the Network Hub Server 300 makes content available to the network by first loading one or more Content Groups 700 into the Content Distribution Queue 310. (FIG. 4, 460). Once the content is completely loaded, the Network Hub Server can then create a “New Content Available” notification message on Event Distribution Queue 340. (FIG. 4, 470). The numerous instances of the Audience App 500, 500′ will receive this notification message via the various wired and/or wireless networks connecting each Audience App to the Network Interface 350. Once notified, the Audience App can proceed to download the content assets using a process flow similar to the one shown in FIG. 5. Note that in this particular embodiment, the content assets may not be available for local use until they have been fully received and “checked in” by being marked as correctly downloaded and available for use by the Audience App. In embodiments, content assets can be requested at regular intervals or as needed by the Audience App; alternatively content assets may be “pushed” to the Audience App by the network Hub Server. Input queue 330 can be used to efficiently receive and process requests and information from Audience Apps and other servers. In an embodiment, if the Audience App is not being actively used, the Audience App may operate in a background state to receive content assets and/or such background execution may be selectively enabled or disabled by the user. Event notifications such as those described above, and even the distribution of the program content stream itself, may optionally take advantage of multicast and/or broadcast capabilities of the data and wireless networks connecting the Audience App devices, if such capabilities are available. In most cases, such optimization requires higher-level interfaces to and with the wireless carriers' networks. Such capability to broadcast or multicast data could additionally be used to minimize the network impact of live-streaming the program content itself over the data and wireless networks connecting the Audience App devices.

In summary, embodiments of the present invention provide a system bring new value and capabilities to broadcast and other shows and program content, and especially adds an element of interactivity and multimedia support that “closes the loop” that has been open since the advent of broadcast programming a century ago. In addition, embodiments facilitate the creation of social communities to discuss, comment upon, and share information about a wide range of topics, thereby potentially increasing the knowledge, connectedness, and understanding of those using it.

### Hardware and Operating Environment

FIG. 12 is a block diagram of a hardware and operating environment in which different implementations can be practiced. The descriptions provide an overview of computer hardware and a suitable computing environment in conjunction with which some embodiments can be implemented. Implementations are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment,

Some embodiments described herein generally relate to a mobile wireless communication device, hereafter referred to as a mobile device. Examples of applicable communication devices include cellular phones, cellular smartphones, wireless organizers, personal digital assistants, pagers, computers, laptops, handheld wireless communication devices, wirelessly enabled notebook computers and the like.

FIG. 12 is a block diagram of a mobile device 1200, according to an implementation. The mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a smartphone, data messaging device, a two-way pager, a cellular telephone with data messaging capabilities, a wireless Internet appliance, or a data communication device (with or without telephony capabilities).

The exemplary mobile device 1200 includes a number of components such as a main processor 1202 that controls the overall operation of the mobile device 1200. Communication functions, including data and voice communications, are performed through a communication subsystem 1204. The communication subsystem 1204 receives messages from and sends messages to wireless networks 1205. Exemplary wireless networks 1205 include 3G, 4G, and 4G LTE (Long Term Evolution) wireless telecommunications networks. In other implementations of the mobile device 1200, the communication subsystem 1204 can be configured in accordance with the Global System for Mobile Communication (GSM), General Packet Radio Services (CPRS), Enhanced Data GSM Environment (EDGE), Universal Mobile Telecommunications Service (UMTS), data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/CPRS networks (as mentioned above), and future third-generation (3G) networks like EDGE and UMTS. Some other examples of data-centric networks include Mobitex™ and DataTAC™ network communication systems. Examples of other voice-centric data networks include Personal Communication Systems (PCS) networks like GSM and Time Division Multiple Access (TDMA) systems.

The wireless link connecting the communication subsystem 1204 with the wireless network 1205 represents one or more different Radio Frequency (RF) channels. With newer network protocols, these channels are capable of supporting both circuit switched voice communications and packet switched data communications.

The main processor 1202 also interacts with additional subsystems such as a Random Access Memory (RAM) 1206, a flash memory 1208, a telephone display, LCD display, or touchscreen display 1211 (which in an embodiment is a resistive or capacitive LCD touchscreen), an auxiliary input/output (I/O) subsystem 1212, a data port 1214, a keyboard 1216 (which in an embodiment may implemented as a touchscreen user interface, and an another embodiment may include an alphabetic keyboard or a telephone keypad), a speaker 1218, a microphone 1220, short-range communications 1222, other device subsystems 1224, one or more orientation detection components (not shown), including an accelerometer, gyroscope, or digital compass, and at least one solid-state image transducer. In some implementations, the flash memory 1208 includes an image-capture-control component. Embodiments of an exemplary mobile device 1200 may also include other device subsystem components, including front-facing and rear-facing camera, GPS (global positioning system) receiver, ambient light sensor, proximity sensor, a radio frequency receiver (e.g., an FM receiver), a headphone jack, antenna components, bio sensor, haptic sensors, and the like. The mobile device also includes a clock (not illustrated) and clock functionality that can be used for synchronizing events.

Some of the subsystems of the mobile device 1200 perform communication-related functions, whereas other subsystems may provide “resident” or on-device functions. By way of example, the display 1211 and the keyboard 1216 may be used for both communication-related functions, such as entering a text message for transmission over the wireless network 1205, and device-resident functions such as a calculator or task list.

The mobile device 1200 is a battery-powered device and includes a battery interface 1232 for receiving one or more batteries 1230. In one or more implementations, the battery 1230 can be a smart battery with an embedded microprocessor. The battery interface 1232 is coupled to a regulator 1233, which assists the battery 1230 in providing power V+ to the mobile device 1200. Although current technology makes use of a battery, future technologies such as micro fuel cells may provide the power to the mobile device 1200.

The mobile device 1200 also includes an operating system 1234 and software components or applications (apps) 1236 to 1246 which are described in more detail below. The operating system 1234 and the software components 1236 to 1246 that are executed by the main processor 1202 are typically stored in a persistent store such as the flash memory 1208, which may alternatively be a read-only memory (ROM) or similar storage element (not shown). Those skilled in the art will appreciate that portions of the operating system 1234 and the software components 1236 to 1246, such as specific device applications, or parts thereof, may be temporarily loaded into a volatile store such as the RAM 1206. Other software components can also be included.

The subset of software components 1236 that control basic device operations, including data and voice communication applications, will normally be installed on the mobile device 1200 during its manufacture. Other software applications include a message application 1238 that can be any suitable software program that allows a user of the mobile device 1200 to transmit and receive electronic messages. Various alternatives exist for the message application 1238 as is well known to those skilled in the art. Messages that have been sent or received by the user are typically stored in the flash memory 1208 of the mobile device 1200 or some other suitable storage element in the mobile device 1200. In one or more implementations, some of the sent and received messages may be stored remotely from the mobile device 1200 such as in a data store of an associated host system with which the mobile device 1200 communicates.

The software applications can further include a device state module 1240, a Personal Information Manager (PIM) 1242, and other suitable modules (not shown). The device state module 1240 provides persistence, i.e. the device state module 1240 ensures that important device data is stored in persistent memory, such as the flash memory 1208, so that the data is not lost when the mobile device 1200 is turned off or loses power.

The mobile device 1200 also includes a connect module 1244. The connect module 1244 implements the communication protocols that are required for the mobile device 1200 to communicate with the wireless infrastructure and any host system, such as an enterprise system, with which the mobile device 1200 is authorized to interface.

Other types of software applications can also be installed on the mobile device 1200. These software applications can be third party applications, which are added after the manufacture of the mobile device 1200. Examples of third party applications include games, calculators, utilities, etc. The Audience App and show prep App applications described above are exemplary software applications that can be installed in an embodiment of mobile device 1200.

The additional applications can be loaded onto the mobile device 1200 through at least one of the wireless network 1205, the auxiliary I/O subsystem 1212, the data port 1214, the short-range communications subsystem 1222, or any other suitable device subsystem 1224. This flexibility in application installation increases the functionality of the mobile device 1200 and may provide enhanced on-device functions, communication-related functions, or bath. For example, secure communication applications may enable electronic commerce functions and other such financial transactions to be performed using the mobile device 1200.

The data port 1214 enables a subscriber to set preferences through an external device or software application and extends the capabilities of the mobile device 1200 by providing for information or software downloads to the mobile device 1200 other than through a wireless communication network. The alternate download path may, for example, be used to load an encryption key onto the mobile device 1200 through a direct and thus reliable and trusted connection to provide secure device communication.

The data port 1214 can be any suitable port that enables data communication between the mobile device 1200 and another computing device. The data port 1214 can be a serial or a parallel port. In some instances, the data port 1214 can be a USB port that includes data lines for data transfer and a supply line that can provide a charging current to charge the battery 1230 of the mobile device 1200.

The short-range communications subsystem 1222 provides for other forms of wireless communication between the mobile device 1200 and different systems or devices, in addition to, or as an alternative to, use of the wireless network 1205. For example, the subsystem 1222 may include an infrared device and associated circuits and components for short-range wireless communication. Examples of short-range communication standards include standards developed by the Infrared Data Association (IrDA), Bluetooth, and the 802.11 family of standards developed by IEEE (Wi-Fi).

In use, a received signal such as a text message, an e-mail message, web page download, streamed data, or other communication or communication packet will be processed by the communication subsystem 1204 and input to the main processor 1202. In an embodiment, the received signal is stored in non-transient storage media such as RAM 1206 or Flash Memory 1208. The main processor 1202 will then process the received signal for output to the display 1211 or alternatively to the auxiliary I/O subsystem 1212. A subscriber may also compose data items, such as e-mail messages, for example, using the keyboard 1216 in conjunction with the display 1211 and possibly the auxiliary I/O subsystem 1212. The auxiliary subsystem 1212 may include devices such as: a touch screen, mouse, track ball, infrared fingerprint detector, or a roller wheel with dynamic button pressing capability. The keyboard 1216 is preferably an alphanumeric keyboard and/or telephone-type keypad. However, other types of keyboards may also be used. A composed item may be transmitted over the wireless network 1205 through the communication subsystem 1204.

For voice communications, the overall operation of the mobile device 1200 is substantially similar, except that the received signals are output to the speaker 1218, and signals for transmission are generated by the microphone 1220. Alternative voice or audio I/O subsystems, such as a voice message recording subsystem, can also be implemented on the mobile device 1200. Although voice or audio signal output is accomplished primarily through the speaker 1218, the display 1211 can also be used to provide additional information such as the identity of a calling party, duration of a voice call, or other voice call related information.

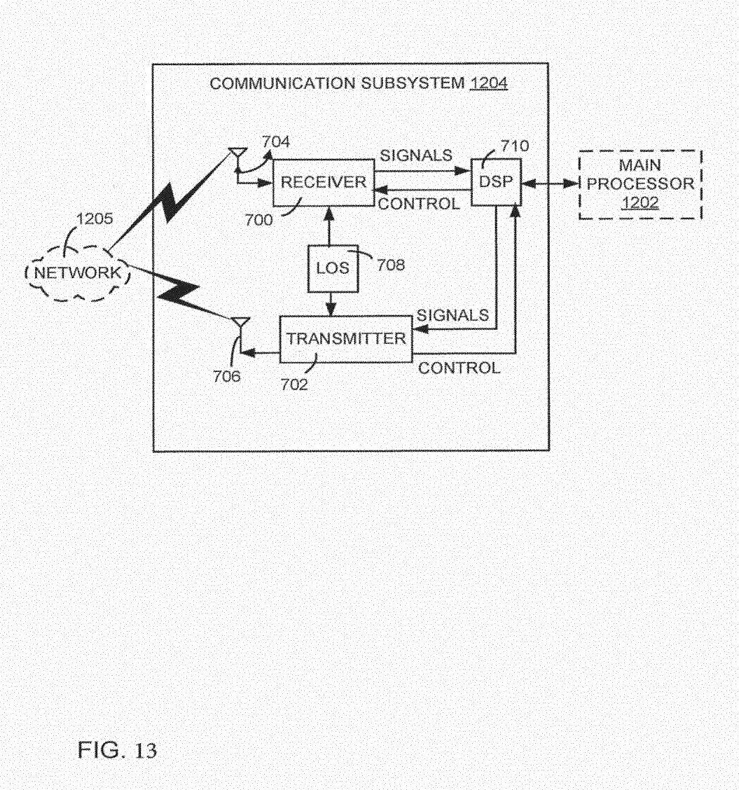

FIG. 13 is a block diagram of an exemplary communication subsystem component 1204 in FIG. 12 is shown. The communication subsystem 1204 includes a receiver 1700, a transmitter 1702, as well as associated components such as one or more embedded or internal antenna elements 1704 and 1706, Local Oscillators (LOs) 1708, and a processing module such as a Digital Signal Processor (DSP) 1710. The particular implementation of the communication subsystem 1204 is dependent upon the communication wireless network 1205 with which the mobile device 1200 is intended to operate. In an embodiment, a wired headphone conductively or operatively connected to the communication subsystem component via a headphone jack functions as an antenna. Thus, it should be understood that the implementation illustrated in FIG. 13 serves only as one example.

Signals received by the antenna 1704 through the wireless network 1205 are input to the receiver 1700, which may perform such common receiver functions as signal amplification, frequency down conversion, filtering, channel selection, and analog-to-digital (A/D) conversion. AID conversion of a received signal allows more complex communication functions such as demodulation and decoding to be performed in the DSP 1710. In a similar manner, signals to be transmitted are processed, including modulation and encoding, by the DSP 1710. These DSP-processed signals are input to the transmitter 1702 for digital-to-analog (D/A) conversion, frequency up conversion, filtering, amplification and transmission over the wireless network 1205 via the antenna 1706. The DSP 1710 not only processes communication signals, but also provides for receiver and transmitter control. For example, the gains applied to communication signals in the receiver 1700 and the transmitter 1702 may be adaptively controlled through automatic gain control algorithms implemented in the DSP 1710.

The wireless link between the mobile device 1200 and the wireless network 1205 can contain one or more different channels, typically different RF channels, and associated protocols used between the mobile device 1200 and the wireless network 1205. An RF channel is a limited resource that must be conserved, typically due to limits in overall bandwidth and limited battery power of the mobile device 1200.

When the mobile device 1200 is fully operational, the transmitter 1702 is typically keyed or turned on only when it is transmitting to the wireless network 1205 and is otherwise turned off to conserve resources. Similarly, the receiver 1700 is periodically turned off to conserve power until the receiver 1700 is needed to receive signals or information (if at all) during designated time periods.

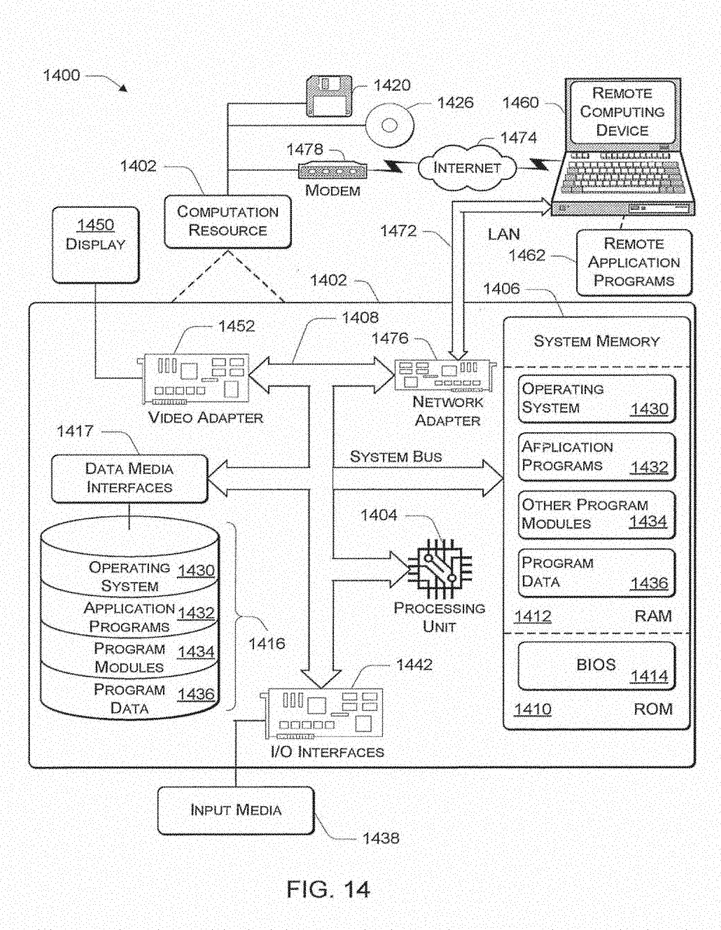

The network hub server, show management server, social history server, and audio fingerprint server are each implemented, in an embodiment, in a general computer environment. The show prep server, in an embodiment, is also implemented in a general computer environment. FIG. 14 illustrates an example of a general computer environment 1400 useful in the context of the environments of FIGS. 1-11 and 15-17, in accordance with embodiments of the disclosed subject matter. The general computer environment 1400 includes a computation resource 1402 capable of implementing the processes described herein. It will be appreciated that other devices can be used that include more components, or fewer components, than those illustrated in FIG. 14.

The illustrated operating environment 1400 is only one example of a suitable operating environment, and the example described with reference to FIG. 14 is not intended to suggest any limitation as to the scope of use or functionality of the implementations of this disclosure. Other well-known computing systems, environments, and/or configurations can be suitable for implementation and/or application of the subject matter disclosed herein.

The computation resource 1402 includes one or more processors or processing units 1404, a system memory 1406, and a bus 1408 that couples various system components including the system memory 1406 to processor(s) 1404 and other elements in the environment 1400. The bus 1408 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 1406 includes nonvolatile read-only memory (ROM) 1410 and random access memory (RAM) 1412, which can or can not include volatile memory elements. A basic input/output system (BIOS) 1414, containing the elementary routines that help to transfer information between elements within computation resource 1402 and with external items, typically invoked into operating memory during start-up, is stored in RUM 1410.

The computation resource 1402 further can include a non-volatile read/write memory 1416, represented in FIG. 14 as a hard disk drive, coupled to bus 1408 via a data media interface 1417 (e.g., a SCSI, ATA, or other type of interface); a magnetic disk drive (not shown) for reading from, and/or writing to, a removable magnetic disk 1420 and an optical disk drive (not shown) for reading from, and/or writing to, a removable optical disk 1426 such as a CD, DVD, or other optical media.

The non-volatile read/write memory 1416 and associated computer-readable media provide nonvolatile storage of computer-readable instructions, data structures, program modules and other data for the computation resource 1402. Although the exemplary environment 1400 is described herein as employing a non-volatile read/write memory 1416, a removable magnetic disk 1420 and a removable optical disk 1426, it will be appreciated by those skilled in the art that other types of computer-readable media which can store data that is accessible by a computer, such as magnetic cassettes, FLASH memory cards, solid-state memory, random access memories (RAMs), read only memories (RUM), and the like, can also be used in the exemplary operating environment.

A number of program modules can be stored via the non-volatile read/write memory 1416, magnetic disk 1420, optical disk 1426, ROM 1410, or RAM 1412, including an operating system 1430, one or more application programs 1432, other program modules 1434 and program data 1436. Examples of computer operating systems conventionally employed include LINUX,® Windows® and MacOS® operating systems, and others, for example, providing capability for supporting application programs 1432 using, for example, code modules written in the C++® computer programming language.

A user can enter commands and information into computation resource 1402 through input devices such as input media 1438 (e.g., keyboard/keypad, tactile input or pointing device, mouse, foot-operated switching apparatus, joystick, touchscreen or touchpad, microphone, antenna etc.). Such input devices 1438 are coupled to the processing unit 1404 through a conventional input/output interface 1442 that is, in turn, coupled to the system bus. A monitor 1450 or other type of display device is also coupled to the system bus 1408 via an interface, such as a video adapter 1452.

The computation resource 1402 can include capability for operating in a networked environment using logical connections to one or more remote computers, such as a remote computer 1460. The remote computer 1460 can be a personal computer, a server, a router, a network PC, a peer device or other common network node, and typically includes any or all of the elements described above relative to the computation resource 1402. In a networked environment, program modules depicted relative to the computation resource 1402, or portions thereof, can be stored in a remote memory storage device such as can be associated with the remote computer 1460. By way of example, remote application programs 1462 reside on a memory device of the remote computer 1460. The logical connections represented in FIG. 14 can include interface capabilities, a storage area network (SAN, not illustrated in FIG. 14), local area network (LAN) 1472 and/or a wide area network (WAN) 1474, but can also include other networks.

Such networking environments are commonplace in modern computer systems, and in association with intranets and the Internet. In certain implementations. The computation resource 1402 executes an Internet Web browser program (which can optionally be integrated into the operating system 1430), such as the “Internet Explorer®”” Web browser manufactured and distributed by the Microsoft Corporation of Redmond, Wash.

When used in a LAN-coupled environment, the computation resource 1402 communicates with or through the local area network 1472 via a network interface or adapter 1476. When used in a WAN-coupled environment, the computation resource 1402 typically includes interfaces, such as a modern 1478, or other apparatus, for establishing communications with or through the WAN 1474, such as the Internet. The modem 1478, which can be internal or external, is coupled to the system bus 1408 via a serial port interface.

The servers described here are implemented using server software and may be hosted on dedicated computing devices, or two or more servers may be hosted on the same computing device.

In a networked environment, program modules depicted relative to the computation resource 1402, or portions thereof, can be stored in remote memory apparatus. It will be appreciated that the network connections shown are exemplary, and other means of establishing a communications link between various computer systems and elements can be used.

A user of a computer can operate in a networked environment using logical connections to one or more remote computers, such as a remote computer 1460, which can be a personal computer, a server, a router, a network PC, a peer device or other common network node. Typically, a remote computer 1460 includes many or all of the elements described above relative to the computer 1400 of FIG. 14.

The computation resource 1402 typically includes at least some form of computer-readable media. Computer-readable media can be any available media that can be accessed by the computation resource 1402. By way of example, and not limitation, computer-readable media can comprise computer storage media and communication media. In an embodiment, the computer-readable media includes non-transient computer-readable media. In an embodiment the computer-readable media includes all forms of computer-readable media except for transient propagated or propagating signals.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 1402.

Communication media typically embodies computer-readable instructions, data structures, program modules. By way of example, and not limitation, communication media include wired media, such as wired network or direct-wired connections, and wireless media, such as acoustic, RF, infrared and other wireless media. The scope of the term computer-readable media includes combinations of any of the above.

In the computer-readable program implementation, the programs can be structured in an object-orientation using an object-oriented language such as Java. Smalltalk or C++, or the programs can be structured in a procedural-orientation using a procedural language such as COBOL or C, or the programs can be structured in a functional-orientation using a functional programming language such as Haskell or Erlang. The software components communicate in any of a number of means that are well-known to those skilled in the art, such as application program interfaces (API) or inter-process communication techniques such as remote procedure call (RPC), common object request broker architecture (CORBA), Component Object Model (COM), Distributed Component Object Model (DCOM), Distributed System Object Model (DSOM) and Remote Method Invocation (RMI), or any of a variety of message queues, message streaming, and other techniques. The components execute on as few as one computer as in general computer environment 1400 in FIG. 14, or on at least as many computers as there are components.

In summary, embodiments of the present invention provide a new and unique set of capabilities, including the capability to close the interactivity loop, providing a powerful platform for transforming traditionally one-way media such as broadcasting and publishing into two-way systems that can not only provide interaction between the audience and the show or media content creators, but also, even between communities of audience members themselves. Far more than just a combination of technologies and systems, though, embodiments of the present invention create new capabilities that Ming new forms of value and social community interaction to program providers and/or broadcasters, their audiences, and their advertisers. In summary, embodiments of the present invention provides a new and unique set of capabilities, including the capability to close the interactivity loop, providing a powerful platform for transforming traditionally one-way media such as broadcasting and publishing into two-way systems that can not only provide interaction between the audience and the show or media content creators, but also, even between communities of audience members themselves.

It should be understood that the disclosed embodiments are illustrative, not restrictive. While specific configurations of the invention have been described relative to radio and TV broadcast shows, it is understood that embodiments of the present invention can be applied to a wide variety of other environments as well to provide interactive augmentation of content that has traditionally not readily allowed closed-loop interactivity. There are many alternative ways of implementing the invention.

The foregoing provides a detailed description of exemplary embodiments to illustrate the principles of the invention. The embodiments are provided to illustrate aspects of the invention, but the invention is not limited to any embodiment. The scope of the invention encompasses numerous alternatives, modifications and equivalents; it is limited only by the claims.

Numerous specific details are set forth in the foregoing description in order to provide a thorough understanding of the invention. However, the invention may be practiced according to the claims without some or all of these specific details. For the purpose of clarity, technical material that is known in the technical fields related to the invention has not been described in detail so the invention is not unnecessarily obscured.

What is claimed is:

1. An audience computing device for interacting with a broadcast program, comprising:
A processor, a memory, a microphone, display means, user input means, and a wireless communication system;
Audience application computer instructions stored in the memory, which when executed by the processor cause the audience computing device to perform the following functions:
Select a broadcast program;
Establish a communication channel between the audience computing device and a remote server, wherein the communication channel comprises a connection established by the wireless communication system;
Transmit program selection data identifying the selected broadcast program to the remote server, via the communication channel;
Receive from the remote server, via the communication channel, auxiliary program information correlated to the selected broadcast program, and store said auxiliary program information in the memory, wherein said auxiliary program information comprises at least one of content, data or instructions;
Using the auxiliary program information, generate local content correlates to the selected broadcast program; and
Display the local content on the display means in temporal coordination with the selected broadcast program.

2. The audience computing device of claim 1, wherein the auxiliary program information determines the timing of the display of local content.

3. The audience computing device of claim 1, wherein said broadcast program comprises a live broadcast.

4. The audience computing device of claim 3, wherein the local content is displayed while the broadcast program is broadcasting live.

5. The audience computing device of claim 4, wherein the display of local content is synchronized with content in the broadcast program.

6. The audience computing device of claim 4, wherein the display of local content is triggered by information received from the remote server via the communication channel while the broadcast program is broadcasting live.

7. The audience computing device of claim 1, wherein the auxiliary program information comprises a generic content template, and the audience application computer instructions stored in the memory further comprise instructions which when executed by the processor cause the audience computing device to generate the local content by combining the generic content template with information received from the remote server via the communication channel.

8. The audience computing device of claim 1, wherein the broadcast program is a previously-recorded or on-demand program.

9. The audience computing device of claim 1, wherein the local content comprises content associated with the content of the selected broadcast program.

10. The audience computing device of claim 1, wherein the auxiliary program information is correlated to demographic information provided by the user of the audience computing device.

11. The audience computing device of claim 10, wherein the audience application computer instructions stored in the memory further comprise instructions which when executed by the processor cause the audience computing device to transmit to the remote server via the communications channel, demographic information provided by the user of the audience computing device.

12. The audience computing device of claim 1, wherein program selection data comprises user selection input received via the input means.

13. The audience computing device of claim 1, wherein the audience application computer instructions stored in the memory further comprise instructions which when executed by the processor cause the audience computing device to generate program selection data based on the broadcaster identification data generated from an ambient broadcast signal.

14. The audience computing device of claim 13, wherein the audience application computer instructions stored in the memory further comprise instructions which when executed by the processor cause the audience computing device to generate an audio stream fingerprint corresponding to the ambient broadcast signal.

15. The audience computing device of claim 1, wherein the audience application computer instructions stored in the memory further comprise instructions which when executed by the processor cause the audience computing device to generate an audio stream fingerprint corresponding to non-transient broadcast content data collected by at least one of the following:
recording, using the microphone, a sample of ambient audio comprising an audible broadcast signal of the broadcast program;
receiving, using a radio frequency receiver, a sample of a broadcast signal of the broadcast program; or
receiving, via the wireless communication system, data comprising a sample of a broadcast signal of the broadcast program.

16. The audience computing device of claim 1, wherein the auxiliary program information further comprise data and instructions for a feedback prompt, and wherein the audience application computer instructions stored in the memory further comprise instructions which when executed by the processor cause the audience computing device to perform the following functions:
Display on the display means prompt input display content generated from the data and instructions for the feedback prompt;
Receive input via the input means in response to the prompt input display content and store input data in the memory;
Transmit the input data via the communication channel to the remote server.

17. The audience computing device of claim 16, wherein the audience application computer instructions stored in the memory further comprise instructions which when executed by the processor cause the audience computing device to:
display prompt input display content in response to broadcast content.

18. The audience computing device of claim 1, wherein the audience application computer instructions stored in the memory further comprise instructions which when executed by the processor cause the audience computing device to perform the following functions:
Using the microphone, record a vocal response to a feedback prompt;
Store vocal response feedback data in memory; and
Transmit the vocal feedback data via the communication channel to the remote server.

19. The audience computing device of claim 1, wherein the auxiliary program information further comprises effectivity and expiry data, priority data, or emergency data.

20. A server component of a broadcasting interactivity system, comprising:
A processor, a memory, and a communication system, wherein the remote server communicates with at least one audience computing device as described in claim 1 via a communications channel comprising at least one wireless communications link,
wherein the memory comprises server computer instructions, which when executed by the processor cause the remote server to perform the following functions:
receive broadcast content correlated with a first broadcast program from a show management server;
receive program selection data identifying the first broadcast program from said audience computing device via the communications channel; and
transmit to the audience computing device via the communications channel auxiliary program information correlated to the first broadcast program.

21. A broadcasting interactivity system, comprising:
A network hub server, comprising the server component of claim 20;
A show management server, comprising a processor, a memory, a communication system, and a show management server user interface, wherein the memory comprises show management server computer instructions, which when executed by the processor cause the show management server to perform at least one of the following functions:
Use the communication system to establish one or more communication links with at least one show prep computing device and with the network hub server;
Store broadcast content data in the memory, where first content data and second content data comprise audio, video, images, web pages, schedules, stopsets, scripts, announcer guidance, advertisements, promotions, computer program instructions, effectivity and expiry data, priority and policy, and programming metadata;
Transmit broadcast content data using the communication system to a show prep computing device;
Receive broadcast content and instruction data from said show prep computing device; or
Transmit broadcast content instruction data to the network hub server;
A show prep computing device, comprising a processor, a memory, a user interface, and a communication system, wherein the memory comprises show prep application computer instructions, which when executed by the processor cause the show prep server to perform at least one of the following functions:
Store first content data and second content data in the memory, where first content data and second content data comprise audio, video, images, web pages, schedules, stopsets, scripts, announcer guidance, advertisements, promotions, computer program instructions, effectivity and expiry data, priority and policy, and programming metadata;
Display information via the user interface regarding the first content data and second content data;
Receive user commands via the user interface to combine first content data and second content data into a content group; or
Distribute the content group to the network hub server or show management server; and
A social history server, comprising a processor, a memory, an operationally-connected database, and a communication system, wherein the memory comprises social history server computer instructions, which when executed by the processor cause the social history server to perform at least one of the following functions:
Maintain in the database audience member data corresponding to each instance of an audience computing device;
Receive from the network hub server social media content received from audience computing devices, wherein social media content comprises at least one of comments, reviews, timeline data, photos, images, video, audio, or demographic information; or
Store in the database social media content received from audience computing devices.

22. The broadcasting interactivity system of claim 21, further comprising an audio fingerprint server comprising a processor, a memory, a communication system, and an operational connection to a database, wherein the memory comprises audio fingerprint server computer instructions, which when executed by the processor cause the audio fingerprint server to perform the following functions:
Collect one or more samples of audio stream data by receiving broadcast content data from the show management server, receiving digitally-streamed audio stream data from a remote source, or receiving audio stream data from a radio frequency receiver;
Store in the memory the one or more samples of audio stream data;
Generate audio stream fingerprint data for each of the one or more samples of audio stream data; and
Transmit said audio stream fingerprint data to the network hub server.

23. The broadcasting interactivity system of claim 22, comprising a first audio fingerprint server serving a first metropolitan area and a second audio fingerprint server serving a different metropolitan area.
